(19) United States
(12) Patent Application Publication
(10) Pub. No.: US 2019/0026833 A1
(43) Pub. Date: Jan. 24, 2019

(54) METHODS AND SYSTEMS FOR CREATING A GOVERNMENT BOND VOLATILITY INDEX AND TRADING DERIVATIVE PRODUCTS BASED THEREON

(71) Applicant: Cboe Exchange, Inc., Chicago, IL (US)

(72) Inventors: Antonio Mele, Cimo (CH); Yoshiki Obayashi, New York, NY (US)

(73) Assignee: Cboe Exchange, Inc., Chicago, IL (US)

(21) Appl. No.: 15/957,467

(22) Filed: Apr. 19, 2018

Related U.S. Application Data
(63) Continuation of application No. 15/049,948, filed on Feb. 22, 2016, now abandoned.
Application No. 15/049,948 is a continuation of application No. 13/970,193, filed on Aug. 19, 2013, now abandoned.
Application No. 13/970,193 is a continuation-in-part of application No. 13/931,114, filed on Jun. 28, 2013, now abandoned.
Application No. 13/931,114 is a continuation-in-part of application No. 13/842,197, filed on Mar. 15, 2013, now abandoned.
(60) Provisional application No. 61/650,150, filed on May 22, 2012.

(51) Int. Cl. G06Q 40/06; G06Q 50/26; G06Q 40/04

(52) U.S. Cl. CPC G06Q 40/06; G06Q 50/26; G06Q 40/04

(57) ABSTRACT

A computer system for calculating a government bond volatility index comprising memory configured to store at least one program; and at least one processor communicatively coupled to the memory, in which the at least one program, when executed by the at least one processor, causes the at least one processor to receive data regarding options on government bond derivatives; calculate, using the data regarding options on government bond derivatives, the government bond volatility index; and transmit data regarding the government bond volatility index.

### RELATED APPLICATION

This application is a continuation of U.S. patent application Ser. No. 15/049,948, filed on Feb. 22, 2017, which was continuation of U.S. application Ser. No. 13/970, 193, filed Aug. 19, 2013, which is a continuation-in-part of pending U.S. application Ser. No. 13/931,114, filed Jun. 28, 2013, which is a continuation-in-part of pending U.S. application Ser. No. 13/842,197, filed Mar. 15, 2013, which claims priority from, now expired, U.S. Provisional Application No. 61/650,150, filed May 22, 2012, each of which is hereby incorporated by reference in its entirety. All patents, patent applications, and references cited anywhere in this specification are hereby incorporated by reference in their entirety.

### FIELD OF THE DISCLOSURE

The present disclosure relates to fixed income derivative investment markets.

### BACKGROUND

A derivative is a financial instrument whose value depends at least in part on the value and/or characteristic(s) of another security, known as an underlying asset. Examples of underlying assets include, but are not limited to: interest rate financial instruments (e.g., bonds), commodities, securities, electronically traded funds, and indices. Two exemplary and well-known derivatives are options and futures contracts.

Derivatives, such as options and futures contracts, may be traded over-the-counter and/or on other trading platforms, such as organized exchanges (e.g., the Chicago Board Options Exchange, Incorporated (“CBOE”)). In over-the-counter transactions the individual parties to a transaction are able to customize each transaction to meet each party's individual needs. With trading platform or exchange traded derivatives, buy and sell orders for standardized derivative contracts are submitted to an exchange where they are matched and executed. Generally, modern trading exchanges have exchange specific computer systems that allow for the electronic submission of orders via electronic communication networks, such as the Internet. An example of an exchange specific computer system is illustrated in FIG. 1.

Once matched and executed, the executed trade is transmitted to a clearing corporation that stands between the holders and writers of derivative contracts. When exchange traded derivatives are exercised, the cash or underlying assets are delivered, when necessary, to the clearing corporation and the clearing corporation disperses the assets as appropriate and defined by the consequence(s) of the trades.

An option contract gives the contract holder a right, but not an obligation, to buy or sell an underlying asset at a specific price on or before a certain date, depending on the option style (e.g., American or European). Conversely, an option contract obligates the seller of the contract to deliver an underlying asset at a specific price on or before a certain date, depending on the option style (e.g., American or European). An American style option may be exercised at any time prior to its expiration. A European style option may be exercised only at its expiration, i.e., at a single pre-defined point in time.

There are generally two types of options: calls and puts. A call option conveys to the holder a right to purchase an underlying asset at a specific price (i.e., the strike price), and obligates the writer to deliver the underlying asset to the holder at the strike price. A put option conveys to the holder a right to sell an underlying asset at a specific price (i.e., the strike price), and obligates the writer to purchase the underlying asset at the strike price.

There are generally two types of settlement processes: physical settlement and cash settlement. During physical settlement, funds are transferred from one party to another in exchange for the delivery of the underlying asset. During cash settlement, funds are delivered from one party to another according to a calculation that incorporates data concerning the underlying asset.

A future contract gives a buyer of the future an obligation to receive delivery of an underlying commodity or asset on a fixed date in the future. Accordingly, a seller of the future contract has the obligation to deliver the commodity or asset on the specified date for a given price. Futures may be settled using physical or cash settlement. Both option and future contracts may be based on abstract market indicators, such as indices, and are typically traded on an exchange. Throughout this application, the term “tenor of the underlying bond” shall refer to the time to maturity of the bond underlying the future, which in turn underlies the future option because the option is written on the future and not directly on the bond.

A forward contract gives a buyer of the forward an obligation to receive delivery of an underlying commodity or asset on a fixed date in the future. Accordingly, a seller of the forward contract has the obligation to deliver the commodity or asset on the specified date for a given price. Forwards may be settled using physical or cash settlement. Forward contracts may be based on abstract market indicators, such as indices, and are typically traded OTC. Throughout this application, the term “tenor of the underlying bond” shall refer to the time to maturity of the bond underlying the forward, which in turn underlies the forward option because the option is written on the forward and not directly on the bond.

An index is a statistical composite that is used to indicate the performance of a market or a market sector over various time periods, i.e., act as a performance benchmark. Examples of indices include the Dow Jones Industrial Average, the National Association of Securities Dealers Automated Quotations (“NASDAQ”) Composite Index, and the Standard & Poor's 500 (“S&P 500®”). As noted above, options on indices are generally cash settled. For example, using cash settlement, a holder of an index call option receives the right to purchase not the index itself, but rather a cash amount equal to the value of the index multiplied by a multiplier, e.g., $100. Thus, if a holder of an index call option exercises the option, the writer of the option must pay the holder, provided the option is in-the-money, the difference between the current value of the underlying index and the strike price multiplied by a multiplier.

Among the indices that derivatives may be based on are those that gauge the volatility of a market or a market subsection. For example, CBOE created and disseminates the CBOE Market Volatility Index or VIX®, which is a key measure of market expectations of near-term volatility conveyed by S&P 500 stock index options prices. Additionally, CBOE offers exchange traded derivative products (both futures and options) that use the VIX as the underlying asset. Volatility indices and the derivative products based thereon have been widely accepted by the financial industry as both a useful tool to hedge positions and as a device for expressing investment views on the direction of volatility.

A government bond is a debt instrument issued by a sovereign entity. Bonds have varying maturities and may make periodic fixed or floating interest payments, i.e. coupons. Depending on the issuing government or the term of the bond, government bonds go by different names, including but not limited to Treasury bill, Treasury note, Treasury bond, German bund, German bobl, German schatz, Japanese government bond (JGB), UK Gilt and so on.

### BRIEF SUMMARY

The inventors have appreciated that, while several volatility indices exist, there currently exists no implementation of a volatility gauge for government bond (GB) markets that is theoretically consistent with prices prevailing in existing markets for options on GB derivatives such as futures and forwards. Particularly, no standardized benchmarks exist to estimate the volatility in the GB markets over a given investment horizon and tenor of the underlying bond. Because no standardized benchmark currently exists that reflects the option-implied fair market value of expected GB volatility, traders, other market participants, and/or money managers currently trade options on GB futures and options to hedge other financial positions, facilitate market-making, and/or take particular investment positions related to market volatility. However, the strategies employed in attempting to hedge risk via the trading of options on GB futures do not necessarily lead to accurate profits and losses due to price dependency, i.e., the tendency to generate profits and losses that are affected by the path of price movements between trade inception and expiry dates rather than the absolute price level prevailing at the time of option expiry.

As such, some embodiments of the invention provide techniques for calculating an effective volatility index related to the GB market. Additionally, some embodiments of the invention provide techniques for instantiating and/or facilitating trading of derivative products based on such an index.

In some embodiments, techniques are provided for creating and disseminating one or more volatility indices calculated using data for options on government bond derivatives such as futures and forwards (i.e., an option granting its owner the right but not the obligation to enter into an underlying bond derivative contract), and facilitating the electronic creation and trading of derivative products based on one or more indices relating to volatility.

Additional features and advantages of the invention will be set forth in the description that follows, and in part will be apparent from the description, or may be learned by practice of the invention. The objectives and advantages of the invention will be realized and attained by the method that is particularly pointed out in the written description and claims hereof as well as the appended drawings.

To achieve these and other advantages, and in accordance with the purpose of the invention, as embodied and broadly described, the present invention provides a computer system for calculating a government bond volatility index comprising memory configured to store at least one program; and at least one processor communicatively coupled to the memory, in which the at least one program, when executed by the at least one processor, causes the at least one processor to receive data regarding options on government bond derivatives; calculate, using the data regarding options on government bond derivatives, the government bond volatility index; and transmit data regarding the government bond volatility index.

In some embodiments, the data regarding options on government bond derivatives includes data regarding prices of options on government bond derivatives.

In one embodiment, the data regarding prices of options on government bond derivatives includes data regarding prices of options on government bond futures or government bond forwards.

In another embodiment, the data regarding prices of options on government bond derivatives includes data regarding prices of European style options on government bond forwards.

In some embodiments, the data regarding prices of options on government bond derivatives includes data regarding prices of options that are not European style options on government bond forwards.

In some embodiments, when the data regarding prices of options on government bond derivatives includes data regarding prices of options that are not European-style options on government bond forwards, converting the data regarding prices of options that are not European-style options on government forwards to data regarding prices of European style options on government bond forwards.

In some embodiments, calculating the government bond volatility index includes valuing a basket of options on the government bond derivatives required for model-independent pricing of a variance swap contract on the government bond derivatives.

In some embodiments, the government bond volatility index is calculated at time t according to the equation:

$$GB - VI ( t , T , {T}_{D} , {T}_{N} ) ≡ 100 \times \sqrt{\frac{1}{( T - t )} [ \begin{matrix}\frac{2}{{P}_{t} ( T )} [ \begin{matrix}{\sum }_{i : {K}_{i} < {K}_{*}} \frac{{Put}_{t} ( {K}_{i} , T , {T}_{D} , {T}_{N} )}{{K}_{i}^{2}} Δ {K}_{i} + \\ {\sum }_{i : {K}_{i} \geq {K}_{*}} \frac{{Call}_{t} ( {K}_{i} , T , {T}_{D} , {T}_{N} )}{{K}_{i}^{2}} Δ {K}_{i}\end{matrix} ] - \\ {( \frac{{F}_{t} ( {T}_{D} , {T}_{N} ) - {K}_{*}}{{K}_{*}} )}^{2}\end{matrix} ]}$$

wherein:

t denotes a time at which the government bond volatility index is calculated;

T denotes a time of expiry of options on government bond derivatives;

T_{D} denotes a time of maturity of government bond derivatives underlying the options where T_{D}≥T;

T_{N} denotes a time of expiry of government bonds;

Z+1 denotes a total number of options used in the index calculation;

K₀ denotes the lowest strike of the Z+1 options;

Kᵢ denotes the i^{th} highest strike of the Z+1 options;

K_{Z} denotes the highest strike of the Z+1 options;

ΔKᵢ=1/2(Kᵢ₊₁−Kᵢ₋₁) for i≥1, and ΔK₀=(K₁−K₀), ΔK_{Z}=(K_{Z}−K_{Z-1});

if the price is observable at time t, then Fₜ(T_{D},T_{N}) is a price at time t of a government bond derivative contract underlying the put and call options, expiring at T_{D} with an underlying government bond maturing at T_{N};

if the price is not observable at time t, then Fₜ(T_{D},T_{N}) is the strike at which the difference between the put and call prices is smallest;

if there exists an option struck at Fₜ(T_{D},T_{N}), then K* equals Fₜ(T_{D},T_{N});

if there does not exist an option struck at Fₜ(T_{D},T_{N}), then K* is the first available strike below Fₜ(T_{D},T_{N});

Pₜ(T) is a price at time t of a zero-coupon non-defaultable bond maturing at T;

Putₜ(Kᵢ,T,T_{D},T_{N}) is a price at time t of a put option, struck at Kᵢ, expiring at T, and having an underlying government bond derivative expiring at T_{D} with an underlying bond maturing at T_{N};

Callᵢ(Kᵢ,T,T_{D},T_{N}) is a price at time t of a call option, struck at Kᵢ, expiring at T, and having an underlying government bond derivative expiring at T_{D} with an underlying bond maturing at T_{N}; and

GB-VI(t,T,T_{D},T_{N})is the value of the government bond volatility index at time t calculated based on options expiring at T on government bond derivatives expiring at T_{D} with an underlying bond maturing at T_{N}.

In some embodiments, the government bond volatility index is calculated at time t according to the equation:

$$GB - {VI}^{bp} ( t , T , {T}_{D} , {T}_{N} ) ≡ {100}^{2} \times \sqrt{\frac{1}{( T - t )} [ \begin{matrix}\frac{2}{{P}_{t} ( T )} [ \begin{matrix}{\sum }_{i : {K}_{i} < {K}_{*}} {Put}_{t} ( {K}_{i} , T , {T}_{D} , {T}_{N} ) Δ {K}_{i} + \\ {\sum }_{i : {K}_{i} \geq {K}_{*}} {Call}_{t} ( {K}_{i} , T , {T}_{D} , {T}_{N} ) Δ {K}_{i}\end{matrix} ] - \\ {( {F}_{t} ( {T}_{D} , {T}_{N} ) - {K}_{*} )}^{2}\end{matrix} ]}$$

wherein:

t denotes a time at which the government bond volatility index is calculated;

T denotes a time of expiry of options on government bond derivatives;

T_{D} denotes a time of maturity of government bond derivatives underlying the options where T_{D}≥T;

T_{N} denotes a time of expiry of government bonds;

Z+1 denotes a total number of options used in the index calculation;

K₀ denotes the lowest strike of the Z+1 options;

Kᵢ denotes the i^{th} highest strike of the Z+1 options;

K_{Z} denotes the highest strike of the Z+1 options;

ΔKᵢ=1/2(Kᵢ₊₁−Kᵢ₋₁) for i≥1, and ΔK₀=(K₁−K₀), ΔK_{Z}=(K_{Z}−K_{Z-1});

if the price is observable at time t, then Fₜ(T_{D},T_{N}) is a price at time t of a government bond derivative contract underlying the put and call options, expiring at T_{D} with an underlying government bond maturing at T_{N};

if the price is not observable at time t, then Fₜ(T_{D},T_{N}) is the strike at which the difference between the put and call prices is smallest;

if there exists an option struck at Fₜ(T_{D},T_{N}), then K* equals Fₜ(T_{D},T_{N});

if there does not exist an option struck at Fₜ(T_{D},T_{N}), then K* is the first available strike below Fₜ(T_{D},T_{N});

Pₜ(T) is a price at time t of a zero-coupon non-defaultable bond maturing at T;

Putₜ(Kᵢ,T,T_{D}, T_{N}) is a price at time t of a put option, struck at Kᵢ, expiring at T, and having an underlying government bond derivative expiring at T_{D} with an underlying bond maturing at T_{N};

Callᵢ(Kᵢ, T, T_{D}, T_{N}) is a price at time t of a call option, struck at Kᵢ, expiring at T, and having an underlying government bond derivative expiring at T_{D} with an underlying bond maturing at T_{N}; and

GB-VI^{bp} (t,T,T_{D},T_{N}) is the value of the government bond volatility index at time t calculated based on options expiring at T on government bond derivatives expiring at T_{D} with an underlying bond maturing at T_{N}.

In some embodiments, in the absence of accrued coupons at time T, the government bond volatility index is calculated at time t according to the equation

$$GB - {VI}_{Y}^{bp} ( t , T , {T}_{D} , {T}_{N} ) ≡ 100 \times {\hat{P}}^{- 1} [ \frac{GB - {VI}^{bp} ( t , T , {T}_{D} , {T}_{N} )}{GB - VI ( t , T , {T}_{D} , {T}_{N} )} ] \times GB - VI ( t , T , {T}_{D} , {T}_{N} )$$

$$where$$

$$\hat{P} ( y ) ≡ {\sum }_{i = 1}^{N} \frac{{C}_{i}}{n} {( 1 + \frac{y}{n} )}^{- i} + 100 {( 1 + \frac{y}{n} )}^{- N} ;$$

and, in the presence of accrued coupons at time T with the next coupon due at tⱼ, the government bond volatility index is calculated at time t according to the equation:

$$GB - {VI}_{Y}^{bp} ( t , T , {T}_{D} , {T}_{N} ) ≡ 100 \times {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] \times GB - VI ( t , T , {T}_{D} , {T}_{N} )$$

$$where$$

$${\hat{P}}_{T} ( x ) ≡ {\sum }_{i = j}^{N} \frac{{C}_{i}}{n} {( 1 + x )}^{- \frac{dc ( {t}_{i} - T )}{dc ( year )}} + 100 {( 1 + x )}^{- \frac{dc ( {t}_{N} - T )}{dc ( year )}}$$

$$and$$

$$GB - VI ( t , T , {T}_{D} , {T}_{N} ) ≡ 100 \times \sqrt{\frac{1}{( T - t )} [ \begin{matrix}\frac{2}{{P}_{t} ( T )} [ \begin{matrix}{\sum }_{i : {K}_{i} < {K}_{*}} \frac{{Put}_{t} ( {K}_{i} , T , {T}_{D} , {T}_{N} )}{{K}_{i}^{2}} Δ {K}_{i} + \\ {\sum }_{i : {K}_{i} \geq {K}_{*}} \frac{{Call}_{t} ( {K}_{i} , T , {T}_{D} , {T}_{N} )}{{K}_{i}^{2}} Δ {K}_{i}\end{matrix} ] - \\ {( \frac{{F}_{t} ( {T}_{D} , {T}_{N} ) - {K}_{*}}{{K}_{*}} )}^{2}\end{matrix} ]}$$

$$and$$

$$GB - {VI}^{bp} ( t , T , {T}_{D} , {T}_{N} ) ≡ {100}^{2} \times \sqrt{\frac{1}{( T - t )} [ \begin{matrix}\frac{2}{{P}_{t} ( T )} [ \begin{matrix}{\sum }_{i : {K}_{i} < {K}_{*}} {Put}_{t} ( {K}_{i} , T , {T}_{D} , {T}_{N} ) Δ {K}_{i} + \\ {\sum }_{i : {K}_{i} \geq {K}_{*}} {Call}_{t} ( {K}_{i} , T , {T}_{D} , {T}_{N} ) Δ {K}_{i}\end{matrix} ] - \\ {( {F}_{t} ( {T}_{D} , {T}_{N} ) - {K}_{*} )}^{2}\end{matrix} ]}$$

wherein:

t denotes a time at which the government bond volatility index is calculated;

T denotes a time of expiry of options on government bond derivatives;

tⱼ is the first coupon payment on or after T;

T_{D} denotes a time of maturity of government bond derivatives underlying the options where T_{D}≥T;

T_{N} denotes a time of expiry of government bonds;

Z+1 denotes a total number of options used in the index calculation;

K₀ denotes the lowest strike of the Z+1 options;

Kᵢ denotes the i^{th} highest strike of the Z+1 options;

K_{Z} denotes the highest strike of the Z+1 options;

ΔKᵢ=1/2(Kᵢ₊₁−Kᵢ₋₁) for i≥1, and ΔK₀=(K₁−K₀), ΔK_{Z}=(K_{Z}−K_{Z-1});

if the price is observable at time t, then Fₜ(T_{D},T_{N}) is a price at time t of a government bond derivative contract underlying the put and call options, expiring at T_{D} with an underlying government bond maturing at T_{N};

if the price is not observable at time t, then Fₜ(T_{D},T_{N}) is the strike at which the difference between the put and call prices is smallest;

if there exists an option struck at Fₜ(T_{D},T_{N}), then K* equals Fₜ(T_{D},T_{N});

if there does not exist an option struck at Fₜ(T_{D},T_{N}), then K* is the first available strike below Fₜ(T_{D},T_{N});

Pₜ(T) is a price at time t of a zero-coupon non-defaultable bond maturing at T;

Putₜ(Kᵢ,T,T_{D},T_{N})is a price at time t of a put option, struck at Kᵢ, expiring at T, and having an underlying government bond derivative expiring at T_{D} with an underlying bond maturing at T_{N};

Callᵢ(Kᵢ, T, T_{D}, T_{N}) is a price at time t of a call option, struck at Kᵢ, expiring at T, and having an underlying government bond derivative expiring at T_{D} with an underlying bond maturing at T_{N};

N denotes the total number of coupon payments of a government bond;

Cᵢ denotes the amount of the i^{th} coupon out of N coupons of a government bond;

n denotes the frequency of coupon payments per annum of a government bond;

y denotes the yield of a government bond;

x denotes the yield of a government bond;

\hat{P}(y) is a bond price corresponding to a bond yield of a coupon-bearing government bond;

\hat{P}⁻¹(y) is the functional inverse of \hat{P}(y);

\hat{P}_{T}(x) is a bond price at time T corresponding to a bond yield of a coupon-bearing government bond;

\hat{P}_{T}⁻¹(x) is the functional inverse of \hat{P}_{T}(x);

dc(year) is the number of days in a year based on a day count convention used for the government bond;

dc(T-t) is the number of days between t and T based on a day count convention used for the government bond;

GB-VI_{Y}^{bp}(t,T,T_{D},T_{N}) is the value of the government bond volatility index in terms of basis point yield volatility at time t calculated based on options expiring at T on government bond derivatives expiring at T_{D} with an underlying bond maturing at T_{N};

GB-VI^{bp}(t,T,T_{D},T_{N}) is the value of the government bond volatility index in terms of basis point price volatility at time t calculated based on options expiring at T on government bond derivatives expiring at T_{D} with an underlying bond maturing at T_{N}; and

GB-VI(t,T,T_{D},T_{N}) is the value of the government bond volatility index in terms of percentage price volatility at time t calculated based on options expiring at T on government bond derivatives expiring at T_{D} with an underlying bond maturing at T_{N}.

In some embodiments, the government bond volatility index is calculated at time t according to the equation:

$$GB - {VI}_{Yd}^{bp} ( t , T , {T}_{D} , {T}_{N} ) ≡ \frac{100 \times ( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] ) \times GB - {VI}^{bp} ( t , T , {T}_{D} , {T}_{N} )}{{\sum }_{i = j}^{N} \frac{{C}_{i}}{n} \begin{matrix}{( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] )}^{- \frac{dc ( {t}_{i} - T )}{dc ( year )}} \frac{dc ( {t}_{i} - T )}{dc ( year )} + \\ 100 {( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] )}^{- \frac{dc ( {t}_{N} - T )}{dc ( year )}} \frac{dc ( {t}_{N} - T )}{dc ( year )}\end{matrix}}$$

$$where$$

$${\hat{P}}_{T} ( x ) ≡ {\sum }_{i = j}^{N} \frac{{C}_{i}}{n} {( 1 + x )}^{- \frac{dc ( {t}_{i} - T )}{dc ( year )}} + 100 {( 1 + x )}^{- \frac{dc ( {t}_{N} - T )}{dc ( year )}}$$

$$and$$

$$GB - VI ( t , T , {T}_{D} , {T}_{N} ) ≡ 100 \times \sqrt{\frac{1}{( T - t )} [ \begin{matrix}\frac{2}{{P}_{t} ( T )} [ \begin{matrix}{\sum }_{i : {K}_{i} < {K}_{*}} \frac{{Put}_{t} ( {K}_{i} , T , {T}_{D} , {T}_{N} )}{{K}_{i}^{2}} Δ {K}_{i} + \\ {\sum }_{i : {K}_{i} \geq {K}_{*}} \frac{{Call}_{t} ( {K}_{i} , T , {T}_{D} , {T}_{N} )}{{K}_{i}^{2}} Δ {K}_{i}\end{matrix} ] - \\ {( \frac{{F}_{t} ( {T}_{D} , {T}_{N} ) - {K}_{*}}{{K}_{*}} )}^{2}\end{matrix} ]}$$

$$and$$

$$GB - {VI}^{bp} ( t , T , {T}_{D} , {T}_{N} ) ≡ {100}^{2} \times \sqrt{\frac{1}{( T - t )} [ \begin{matrix}\frac{2}{{P}_{t} ( T )} [ \begin{matrix}{\sum }_{i : {K}_{i} < {K}_{*}} {Put}_{t} ( {K}_{i} , T , {T}_{D} , {T}_{N} ) Δ {K}_{i} + \\ {\sum }_{i : {K}_{i} \geq {K}_{*}} {Call}_{t} ( {K}_{i} , T , {T}_{D} , {T}_{N} ) Δ {K}_{i}\end{matrix} ] - \\ {( {F}_{t} ( {T}_{D} , {T}_{N} ) - {K}_{*} )}^{2}\end{matrix} ]}$$

wherein:

t denotes a time at which the government bond volatility index is calculated;

T denotes a time of expiry of options on government bond derivatives;

T_{D} denotes a time of maturity of government bond derivatives underlying the options where T_{D}≥T;

T_{N} denotes a time of expiry of government bonds;

Z+1 denotes a total number of options used in the index calculation;

K₀ denotes the lowest strike of the Z+1 options;

Kᵢ denotes the i^{th} highest strike of the Z+1 options;

K_{Z} denotes the highest strike of the Z+1 options;

ΔKᵢ=1/2(Kᵢ₊₁−Kᵢ₋₁) for i≥1, and ΔK₀=(K₁−K₀), ΔK_{Z}=(K_{Z}−K_{Z-1});

if the price is observable at time t, then Fₜ(T_{D},T_{N}) is a price at time t of a government bond derivative contract underlying the put and call options, expiring at T_{D} with an underlying government bond maturing at T_{N};

if the price is not observable at time t, then Fₜ(T_{D},T_{N}) is the strike at which the difference between the put and call prices is smallest;

if there exists an option struck at Fₜ(T_{D},T_{N}), then K* equals Fₜ(T_{D},T_{N});

if there does not exist an option struck at Fₜ(T_{D},T_{N}), then K* is the first available strike below Fₜ(T_{D},T_{N});

Pₜ(T) is a price at time t of a zero-coupon non-defaultable bond maturing at T;

Putₜ(Kᵢ,T,T_{D},T_{N}) is a price at time t of a put option, struck at Kᵢ, expiring at T, and having an underlying government bond derivative expiring at T_{D} with an underlying bond maturing at T_{N};

Callₜ(Kᵢ,T,T_{D},T_{N})is a price at time t of a call option, struck at Kᵢ, expiring at T, and having an underlying government bond derivative expiring at T_{D} with an underlying bond maturing at T_{N};

N denotes the total number of coupon payments of a government bond;

Cᵢ denotes the amount of the i^{th} coupon out of N coupons of a government bond;

n denotes the frequency of coupon payments per annum of a government bond;

x denotes the yield of a government bond;

\hat{P}_{T}(x) is a bond price corresponding to a bond yield of a coupon-bearing government bond;

\hat{P}T⁻¹(x) is the functional inverse of \hat{P}_{T}(x);

dc(year) is the number of days in a year based on a day count convention used for the government bond;

dc(T-t)is the number of days between t and T based on a day count convention used for the government bond;

tⱼ is the first coupon payment on or after T;

GB-VI_{Yd}^{bp}(t,T,T_{D},T_{N}) is the value of the government bond volatility index in terms of basis point yield volatility at time t calculated based on options expiring at T on government bond derivatives expiring at T_{D} with an underlying bond maturing at T_{N};

GB-VI^{bp}(t,T,T_{D},T_{N}) is the value of the government bond volatility index in terms of basis point price volatility at time t calculated based on options expiring at T on government bond derivatives expiring at T_{D} with an underlying bond maturing at T_{N}; and

GB-VI(t,T,T_{D},T_{N}) is the value of the government bond volatility index in terms of percentage price volatility at time t calculated based on options expiring at T on government bond derivatives expiring at T_{D} with an underlying bond maturing at T_{N}.

In some embodiments, the at least one processor is further caused to create a standardized exchange-traded derivative instrument based on the government bond volatility index; and transmit data regarding the standardized exchange-traded derivative.

In some embodiments, transmitting data regarding the standardized exchange-traded derivative instrument includes transmitting data regarding one or more of a settlement price, a bid price, an offer price, or a trade price of the standardized exchange-traded derivative instrument.

In another embodiment, a non-transitory computer readable storage medium having computer-executable instructions recorded thereon that, when executed on a computer, configure the computer to perform a method to calculate a government bond volatility index, the method comprising receiving data regarding options on government bond derivatives; calculating, using the data regarding options on government bond derivatives, the government bond volatility index; and transmitting data regarding the government bond volatility index.

In some embodiments of the non-transitory computer readable storage medium, the data regarding options on government bond derivatives includes data regarding prices of options on government bond derivatives.

In one embodiment of the non-transitory computer readable storage medium, the data regarding prices of options on government bond derivatives includes data regarding prices of options on government bond futures or government bond forwards.

In some embodiments of the non-transitory computer readable storage medium, the data regarding prices of options on government bond derivatives includes data regarding prices of European style options on government bond forwards.

In some embodiments of the non-transitory computer readable storage medium, the data regarding prices of options on government bond derivatives includes data regarding prices of options that are not European style options on government bond forwards.

In some embodiments of the non-transitory computer readable storage medium, when the data regarding prices of options on government bond derivatives includes data regarding prices of options that are not European-style options on government bond forwards, converting the data regarding prices of options that are not European-style options on government bond forwards to data regarding prices of European style options on government bond forwards.

In some embodiments of the non-transitory computer readable storage medium, calculating the government bond volatility index includes valuing a basket of options on the government bond derivatives required for model-independent pricing of a variance swap contract on the government bond derivatives.

In some embodiments of the non-transitory computer readable storage medium, the government bond volatility index is calculated at time t according to the equation:

$$GB - VI ( t , T , {T}_{D} , {T}_{N} ) ≡ 100 \times \sqrt{\frac{1}{( T - t )} [ \begin{matrix}\frac{2}{{P}_{t} ( T )} [ \begin{matrix}{\sum }_{i : {K}_{i} < {K}_{*}} \frac{{Put}_{t} ( {K}_{i} , T , {T}_{D} , {T}_{N} )}{{K}_{i}^{2}} Δ {K}_{i} + \\ {\sum }_{i : {K}_{i} \geq {K}_{*}} \frac{{Call}_{t} ( {K}_{i} , T , {T}_{D} , {T}_{N} )}{{K}_{i}^{2}} Δ {K}_{i}\end{matrix} ] - \\ {( \frac{{F}_{t} ( {T}_{D} , {T}_{N} ) - {K}_{*}}{{K}_{*}} )}^{*}\end{matrix} ]}$$

wherein:

t denotes a time at which the government bond volatility index is calculated;

T denotes a time of expiry of options on government bond derivatives;

T_{D} denotes a time of maturity of government bond derivatives underlying the options where T_{D}≥T;

T_{N} denotes a time of expiry of government bonds;

Z+1 denotes a total number of options used in the index calculation;

K₀ denotes the lowest strike of the Z+1 options;

Kᵢ denotes the i^{th} highest strike of the Z+1 options;

K_{Z} denotes the highest strike of the Z+1 options;

ΔKᵢ=1/2(Kᵢ₊₁−Kᵢ₋₁) for i≥1, and ΔK₀=(K₁−K₀), ΔK_{Z}=(K_{Z}−K_{Z-1});

if the price is observable at time t, then Fₜ(T_{D},T_{N}) is a price at time t of a government bond derivative contract underlying the put and call options, expiring at T_{D} with an underlying government bond maturing at T_{N};

if the price is not observable at time t, then Fₜ(T_{D},T_{N}) is the strike at which the difference between the put and call prices is smallest;

if there exists an option struck at Fₜ(T_{D},T_{N}), then K* equals Fₜ(T_{D},T_{N});

if there does not exist an option struck at Fₜ(T_{D},T_{N}), then K* is the first available strike below Fₜ(T_{D},T_{N});

Pₜ(T) is a price at time t of a zero-coupon non-defaultable bond maturing at T;

Putₜ(Kᵢ,T,T_{D},T_{N}) is a price at time t of a put option, struck at Kᵢ, expiring at T, and having an underlying government bond derivative expiring at T_{D} with an underlying bond maturing at T_{N};

Callₜ(Kᵢ,T,T_{D},T_{N}) is a price at time t of a call option, struck at Kᵢ, expiring at T, and having an underlying government bond derivative expiring at T_{D} with an underlying bond maturing at T_{N}; and

GB-VI(t,T,T_{D},T_{N}) is the value of the government bond volatility index at time t calculated based on options expiring at T on government bond derivatives expiring at T_{D} with an underlying bond maturing at T_{N}.

In some embodiments of the non-transitory computer readable storage medium, the government bond volatility index is calculated at time t according to the equation:

$$GB - {VI}^{bp} ( t , T , {T}_{D} , {T}_{N} ) ≡ {100}^{2} \times \sqrt{\frac{1}{( T - t )} [ \begin{matrix}\frac{2}{{P}_{t} ( T )} [ \begin{matrix}{\sum }_{i : {K}_{i} < {K}_{*}} {Put}_{t} ( {K}_{i} , T , {T}_{D} , {T}_{N} ) Δ {K}_{i} + \\ {\sum }_{i : {K}_{i} \geq {K}_{*}} {Call}_{t} ( {K}_{i} , T , {T}_{D} , {T}_{N} ) Δ {K}_{i}\end{matrix} ] - \\ {( {F}_{t} ( {T}_{D} , {T}_{N} ) - {K}_{*} )}^{2}\end{matrix} ]}$$

wherein:

t denotes a time at which the government bond volatility index is calculated;

T denotes a time of expiry of options on government bond derivatives;

T_{D} denotes a time of maturity of government bond derivatives underlying the options where T_{D}≥T;

T_{N} denotes a time of expiry of government bonds;

Z+1 denotes a total number of options used in the index calculation;

K₀ denotes the lowest strike of the Z+1 options;

Kᵢ denotes the i^{th} highest strike of the Z+1 options;

K_{Z} denotes the highest strike of the Z+1 options;

ΔKᵢ=1/2(Kᵢ₊₁−Kᵢ₋₁) for i≥1, and ΔK₀=(K₁−K₀), ΔK_{Z}=(K_{Z}−K_{Z-1});

if the price is observable at time t, then Fₜ(T_{D},T_{N}) is a price at time t of a government bond derivative contract underlying the put and call options, expiring at T_{D} with an underlying government bond maturing at T_{N};

if the price is not observable at time t, then Fₜ(T_{D},T_{N}) is the strike at which the difference between the put and call prices is smallest;

if there exists an option struck at Fₜ(T_{D},T_{N}), then K* equals Fₜ(T_{D},T_{N});

if there does not exist an option struck at Fₜ(T_{D},T_{N}), then K* is the first available strike below Fₜ(T_{D},T_{N});

Pₜ(T) is a price at time t of a zero-coupon non-defaultable bond maturing at T;

Putₜ(KᵢT,T_{D},T_{N}) is a price at time t of a put option, struck at Kᵢ, expiring at T, and having an underlying government bond derivative expiring at T_{D} with an underlying bond maturing at T_{N};

Callₜ(Kᵢ,T,T_{D},T_{N}) is a price at time t of a call option, struck at Kᵢ, expiring at T, and having an underlying government bond derivative expiring at T_{D} with an underlying bond maturing at T_{N}; and

GB-VI^{bp}(t,T,T_{D},T_{N}) is the value of the government bond volatility index at time t calculated based on options expiring at T on government bond derivatives expiring at T_{D} with an underlying bond maturing at T_{N}.

In some embodiments of the non-transitory computer readable storage medium, in the absence of accrued coupons at time T, the government bond volatility index is calculated at time t according to the equation

$$GB - {VI}_{Y}^{bp} ( t , T , {T}_{D} , {T}_{N} ) ≡ 100 \times {\hat{P}}^{- 1} [ \frac{GB - {VI}^{bp} ( t , T , {T}_{D} , {T}_{N} )}{GB - VI ( t , T , {T}_{D} , {T}_{N} )} ] \times GB - VI ( t , T , {T}_{D} , {T}_{N} )$$

$$where$$

$$\hat{P} ( x ) ≡ {\sum }_{i = 1}^{N} \frac{{C}_{i}}{n} {( 1 + \frac{y}{n} )}^{- i} + 100 {( 1 + \frac{y}{n} )}^{- N} ;$$

and, in the presence of accrued coupons at time T with the next coupon due at tⱼ, the government bond volatility index is calculated at time t according to the equation:

$$GB - {VI}_{Y}^{bp} ( t , T , {T}_{D} , {T}_{N} ) ≡ 100 \times {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] \times GB - VI ( t , T , {T}_{D} , {T}_{N} )$$

$$where$$

$${\hat{P}}_{T} ( x ) ≡ {\sum }_{i = j}^{N} \frac{{C}_{i}}{n} {( 1 + x )}^{- \frac{dc ( {t}_{i} - T )}{dc ( year )}} + 100 {( 1 + x )}^{- \frac{dc ( {t}_{N} - T )}{dc ( year )}}$$

$$and$$

$$GB - VI ( t , T , {T}_{D} , {T}_{N} ) ≡ 100 \times \sqrt{\frac{1}{( T - t )} [ \begin{matrix}\frac{2}{{P}_{t} ( T )} [ \begin{matrix}{\sum }_{i : {K}_{i} < {K}_{*}} \frac{{Put}_{t} ( {K}_{i} , T , {T}_{D} , {T}_{N} )}{{K}_{i}^{2}} Δ {K}_{i} + \\ {\sum }_{i : {K}_{i} \geq {K}_{*}} \frac{{Call}_{t} ( {K}_{i} , T , {T}_{D} , {T}_{N} )}{{K}_{i}^{2}} Δ {K}_{i}\end{matrix} ] - \\ {( \frac{{F}_{t} ( {T}_{D} , {T}_{N} ) - {K}_{*}}{{K}_{*}} )}^{2}\end{matrix} ]}$$

$$and$$

$$GB - {VI}^{bp} ( t , T , {T}_{D} , {T}_{N} ) ≡ {100}^{2} \times \sqrt{\frac{1}{( T - t )} [ \begin{matrix}\frac{2}{{P}_{t} ( T )} [ \begin{matrix}{\sum }_{i : {K}_{i} < {K}_{*}} {Put}_{t} ( {K}_{i} , T , {T}_{D} , {T}_{N} ) Δ {K}_{i} + \\ {\sum }_{i : {K}_{i} \geq {K}_{*}} {Call}_{t} ( {K}_{i} , T , {T}_{D} , {T}_{N} ) Δ {K}_{i}\end{matrix} ] - \\ {( {F}_{t} ( {T}_{D} , {T}_{N} ) - {K}_{*} )}^{2}\end{matrix} ]}$$

wherein:

t denotes a time at which the government bond volatility index is calculated;

T denotes a time of expiry of options on government bond derivatives;

tⱼ is the first coupon payment on or after T;

T_{D} denotes a time of maturity of government bond derivatives underlying the options where T_{D}≥T;

T_{N} denotes a time of expiry of government bonds;

Z+1 denotes a total number of options used in the index calculation;

K₀ denotes the lowest strike of the Z+1 options;

Kᵢ denotes the i^{th} highest strike of the Z+1 options;

K_{Z} denotes the highest strike of the Z+1 options;

ΔKᵢ=1/2(Kᵢ₊₁−Kᵢ₋₁) for i≥1, and ΔK₀=(K₁−K₀), ΔK_{Z}=(K_{Z}−K_{Z-1});

if the price is observable at time t, then Fₜ(T_{D},T_{N}) is a price at time t of a government bond derivative contract underlying the put and call options, expiring at T_{D} with an underlying government bond maturing at T_{N};

if the price is not observable at time t, then Fₜ(T_{D},T_{N}) is the strike at which the difference between the put and call prices is smallest;

if there exists an option struck at Fₜ(T_{D},T_{N}), then K* equals Fₜ(T_{D},T_{N});

if there does not exist an option struck at Fₜ(T_{D},T_{N}), then K* is the first available strike below Fₜ(T_{D},T_{N});

Pₜ(T) is a price at time t of a zero-coupon non-defaultable bond maturing at T;

Putₜ(Kᵢ,T,T_{D},T_{N}) is a price at time t of a put option, struck at Kᵢ, expiring at T, and having an underlying government bond derivative expiring at T_{D} with an underlying bond maturing at T_{N};

Callₜ(Kᵢ,T,T_{D},T_{N}) is a price at time t of a call option, struck at Kᵢ, expiring at T, and having an underlying government bond derivative expiring at T_{D} with an underlying bond maturing at T_{N};

N denotes the total number of coupon payments of a government bond;

Cᵢ denotes the amount of the i^{th} coupon out of N coupons of a government bond;

n denotes the frequency of coupon payments per annum of a government bond;

y denotes the yield of a government bond;

x denotes the yield of a government bond;

\hat{P}(y) is a bond price corresponding to a bond yield of a coupon-bearing government bond;

\hat{P}⁻¹(y) is the functional inverse of \hat{P}(y);

\hat{P}_{T}(x) is a bond price at time T corresponding to a bond yield of a coupon-bearing government bond;

\hat{P}_{T}⁻¹(x) is the functional inverse of \hat{P}_{T}(x);

dc(year) is the number of days in a year based on a day count convention used for the government bond;

dc(T-t)is the number of days between t and T based on a day count convention used for the government bond; GB-VI_{Y}^{bp}(t,T,T_{D},T_{N}) is the value of the government bond volatility index in terms of basis point yield volatility at time t calculated based on options expiring at T on government bond derivatives expiring at T_{D} with an underlying bond maturing at T_{N};

GB-VI^{bp}(t,T,T_{D},T_{N}) is the value of the government bond volatility index in terms of basis point price volatility at time t calculated based on options expiring at T on government bond derivatives expiring at T_{D} with an underlying bond maturing at T_{N}; and

GB-VI(t,T,T_{D},T_{N}) is the value of the government bond volatility index in terms of percentage price volatility at time t calculated based on options expiring at T on government bond derivatives expiring at T_{D} with an underlying bond maturing at T_{N}.

In some embodiments of the non-transitory computer readable storage medium, the government bond volatility index is calculated at time t according to the equation:

$$GB - {VI}_{Yd}^{bp} ( t , T , {T}_{D} , {T}_{N} ) ≡ \frac{100 \times ( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] ) \times GB - {VI}^{bp} ( t , T , {T}_{D} , {T}_{N} )}{{\sum }_{i = j}^{N} \frac{{C}_{i}}{n} \begin{matrix}{( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] )}^{- \frac{dc ( {t}_{i} - T )}{dc ( year )}} \frac{dc ( {t}_{i} - T )}{dc ( year )} + \\ 100 {( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] )}^{- \frac{dc ( {t}_{N} - T )}{dc ( year )}} \frac{dc ( {t}_{N} - T )}{dc ( year )}\end{matrix}}$$

$$where$$

$${\hat{P}}_{T} ( x ) ≡ {\sum }_{i = j}^{N} \frac{{C}_{i}}{n} {( 1 + x )}^{- \frac{dc ( {t}_{i} - T )}{dc ( year )}} + 100 {( 1 + x )}^{- \frac{dc ( {t}_{N} - T )}{dc ( year )}}$$

$$and$$

$$GB - VI ( t , T , {T}_{D} , {T}_{N} ) ≡ 100 \times \sqrt{\frac{1}{( T - t )} [ \begin{matrix}\frac{2}{{P}_{t} ( T )} [ \begin{matrix}{\sum }_{i : {K}_{i} < {K}_{*}} \frac{{Put}_{t} ( {K}_{i} , T , {T}_{D} , {T}_{N} )}{{K}_{i}^{2}} Δ {K}_{i} + \\ {\sum }_{i : {K}_{i} \geq {K}_{*}} \frac{{Call}_{t} ( {K}_{i} , T , {T}_{D} , {T}_{N} )}{{K}_{i}^{2}} Δ {K}_{i}\end{matrix} ] - \\ {( \frac{{F}_{t} ( {T}_{D} , {T}_{N} ) - {K}_{*}}{{K}_{*}} )}^{2}\end{matrix} ]}$$

$$and$$

$$GB - {VI}^{bp} ( t , T , {T}_{D} , {T}_{N} ) ≡ {100}^{2} \times \sqrt{\frac{1}{( T - t )} [ \begin{matrix}\frac{2}{{P}_{t} ( T )} [ \begin{matrix}{\sum }_{i : {K}_{i} < {K}_{*}} {Put}_{t} ( {K}_{i} , T , {T}_{D} , {T}_{N} ) Δ {K}_{i} + \\ {\sum }_{i : {K}_{i} \geq {K}_{*}} {Call}_{t} ( {K}_{i} , T , {T}_{D} , {T}_{N} ) Δ {K}_{i}\end{matrix} ] - \\ {( {F}_{t} ( {T}_{D} , {T}_{N} ) - {K}_{*} )}^{2}\end{matrix} ]}$$

wherein:

t denotes a time at which the government bond volatility index is calculated;

T denotes a time of expiry of options on government bond derivatives;

T_{D} denotes a time of maturity of government bond derivatives underlying the options where T_{D}≥T;

T_{N} denotes a time of expiry of government bonds;

Z+1 denotes a total number of options used in the index calculation;

K₀ denotes the lowest strike of the Z+1 options;

Kᵢ denotes the i^{th} highest strike of the Z+1 options;

K_{Z} denotes the highest strike of the Z+1 options;

ΔKᵢ=1/2(Kᵢ₊₁−Kᵢ₋₁) for i≥1, and ΔK₀=(K₁−K₀), ΔK_{Z}=(K_{Z}−K_{Z-1});

if the price is observable at time t, then Fₜ(T_{D},T_{N}) is a price at time t of a government bond derivative contract underlying the put and call options, expiring at T_{D} with an underlying government bond maturing at T_{N};

if the price is not observable at time t, then Fₜ(T_{D},T_{N}) is the strike at which the difference between the put and call prices is smallest;

if there exists an option struck at Fₜ(T_{D},T_{N}), then K* equals Fₜ(T_{D},T_{N});

if there does not exist an option struck at Fₜ(T_{D},T_{N}), then K* is the first available strike below Fₜ(T_{D},T_{N});

Pₜ(T) is a price at time t of a zero-coupon non-defaultable bond maturing at T;

Putₜ(Kᵢ,T,T_{D},T_{N}) is a price at time t of a put option, struck at Kᵢ, expiring at T, and having an underlying government bond derivative expiring at T_{D} with an underlying bond maturing at T_{N};

Callₜ(Kᵢ,T,T_{D},T_{N}) is a price at time t of a call option, struck at Kᵢ, expiring at T, and having an underlying government bond derivative expiring at T_{D} with an underlying bond maturing at T_{N};

N denotes the total number of coupon payments of a government bond;

Cᵢ denotes the amount of the i^{th} coupon out of N coupons of a government bond;

n denotes the frequency of coupon payments per annum of a government bond;

x denotes the yield of a government bond;

\hat{P}_{T}(x) is a bond price corresponding to a bond price to bond yield of a coupon-bearing government bond;

\hat{P}_{T}⁻¹(x) is the functional inverse of \hat{P}_{T}(x);

dc(year) is the number of days in a year based on a day count convention used for the government bond;

dc(T-t)is the number of days between t and T based on a day count convention used for the government bond;

tⱼ is the first coupon payment on or after T;

GB-VI_{Yd}^{bp}(t,T,T_{D},T_{N}) is the value of the government bond volatility index in terms of basis point yield volatility at time t calculated based on options expiring at T on government bond derivatives expiring at T_{D} with an underlying bond maturing at T_{N};

GB-VI^{bp}(t,T,T_{D},T_{N}) is the value of the government bond volatility index in terms of basis point price volatility at time t calculated based on options expiring at T on government bond derivatives expiring at T_{D} with an underlying bond maturing at T_{N}; and

GB-VI(t,T,T_{D},T_{N}) is the value of the government bond volatility index in terms of percentage price volatility at time t calculated based on options expiring at T on government bond derivatives expiring at T_{D} with an underlying bond maturing at T_{N}.

In some embodiments of the non-transitory computer readable storage medium, the at least one processor is further caused to create a standardized exchange-traded derivative instrument based on the government bond volatility index; and transmit data regarding the standardized exchange-traded derivative.

In some embodiments of the non-transitory computer readable storage medium, transmitting data regarding the standardized exchange-traded derivative instrument includes transmitting data regarding one or more of a settlement price, a bid price, an offer price, or a trade price of the standardized exchange-traded derivative instrument.

The foregoing is a non-limiting summary of the invention, some embodiments of which are defined by the attached claims.

### BRIEF DESCRIPTION OF THE DRAWINGS

FIG. 1 is a diagram of a financial exchange's computerized trading system;

FIG. 2 is a diagram of a financial exchange's back end trading system;

FIG. 3 is a flow diagram of a method of calculating a Basis Point GB price volatility index;

FIG. 4 is a flow diagram of a method of calculating a Percentage GB price volatility index;

FIG. 5 is a diagram of a general purpose computer system that can be modified via computer hardware or software to be customized and specialized so as to be suitable for use in a financial exchanges computerized trading system; and

FIG. 6 is a flow diagram of a method of calculating a Basis Point GB yield volatility index.

FIG. 7 is a flow diagram of a method of calculating a Modified Duration-Based Basis Point GB yield volatility index.

### DETAILED DESCRIPTION OF THE PREFERRED EMBODIMENTS

Some embodiments of the present invention can be implemented on financial exchange systems and/or other known financial industry systems, whether now known or later developed. Typically, financial exchange systems and other known financial industry systems utilize a combination of computer hardware (e.g., client and server computers, which may include computer processors, memory, storage, input and output devices, and other known components of computer systems; electronic communication equipment, such as electronic communication lines, routers, switches, etc; electronic information storage systems, such as network-attached storage and storage area networks) and computer software (i.e., the instructions that cause the computer hardware to function in a specific way) to achieve the desired system performance. It should be noted that financial exchange systems may be floor-based open outcry systems, pure electronic systems, or some combination of floor-based open outcry and pure electronic systems.

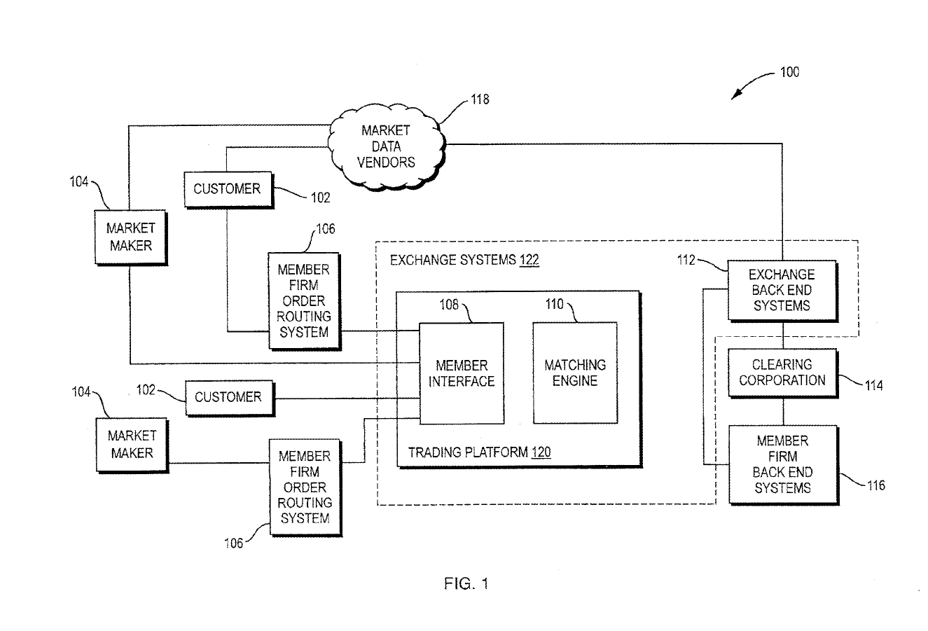

FIG. 1 illustrates an electronic trading system 100 which may be used for creating and disseminating a GB future option-based index (such as a GB volatility index) and/or creating, listing and trading derivative contracts that are based on a GB future option index. One having ordinary skill in the art would readily understand that system 100, as described in detail below, would be implemented utilizing a combination of computer hardware and software, as described in the paragraph above. It will be appreciated that the described systems may implement the methods described below.

The system 100 includes components operated by an exchange, as well as components operated by others who access the exchange to execute trades. The components shown within the dashed lines are those operated by the exchange. Components outside the dashed lines are operated by others, but nonetheless are necessary for the operation of a functioning exchange. The exchange components 122 of the trading system 100 include an electronic trading platform 120, a member interface 108, a matching engine 110, and backend systems 112. Backend systems not operated by the exchange but which are integral to processing trades and settling contracts are the Clearing Corporation's systems 114, and Member Firms' backend systems 116.

Market Makers may access the trading platform 120 directly through personal input devices 104 which communicate with the member interface 108. Market makers may quote prices for the derivative contracts of the present invention, e.g., GB volatility index derivative contracts. Non-member Customers 102, however, must access the exchange through a Member Firm. Customer orders are routed through Member Firm routing systems 106. The Member Firm routing systems 106 forward the orders to the exchange via the member interface 108. The member interface 108 manages all communications between the Member Firm routing systems 106 and Market Makers' personal input devices 104; determines whether orders may be processed by the trading platform; and determines the appropriate matching engine for processing the orders. Although only a single matching engine 110 is shown in system 100, the trading platform 120 may include multiple matching engines. Different exchange traded products may be allocated to different matching engines for efficient execution of trades. When the member interface 102 receives an order from a Member Firm routing system 106, the member interface 108 determines the proper matching engine 110 for processing the order and forwards the order to the appropriate matching engine. The matching engine 110 executes trades by pairing corresponding marketable buy/sell orders. Non-marketable orders are placed in an electronic order book.

Once orders are executed, the matching engine 110 sends details of the executed transactions to the exchange backend systems 112, to the Clearing Corporation systems 114, and to the Member Firm backend systems 116. The matching engine also updates the order book to reflect changes in the market based on the executed transactions. Orders that previously were not marketable may become marketable due to changes in the market. If so, the matching engine 110 executes these orders as well.

The exchange backend systems 112 perform a number of different functions. For example, contract definition and listing data originate with the Exchange backend systems 112. The GB future option indices of the present invention, e.g., the GB volatility indices described below, and pricing information for derivative contracts associated with the indices of the present invention are disseminated from the exchange backend systems to market data vendors 118. Customers 102, market makers 104, and others may access the market data regarding the indices of the present invention and the derivative contracts based on the indices of the present invention via, for example, proprietary networks, on-line services, and the like.

The exchange backend systems also evaluate the underlying asset or assets on which the derivative contracts of the present invention are based. At expiration, the backend systems 112 determine the appropriate settlement amounts and supply final settlement data to the Clearing Corporation 114. The Clearing Corporation 114 acts as the exchange's bank and performs a final mark-to-market on Member Firm margin accounts based on the positions taken by the Member Firms' customers. The final mark-to-market reflects the final settlement amounts for the derivative contracts of the present invention, and the Clearing Corporation debits/credits Member Firms' accounts accordingly. These data are also forwarded to the Member Firms' systems 116 so that they may update their customer accounts as well.

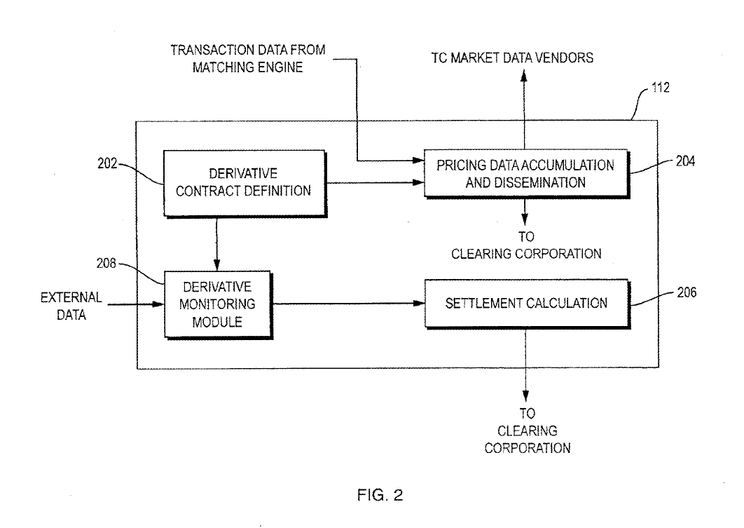

FIG. 2 shows an embodiment of the exchange backend systems 112 used for creating and disseminating an index of the present invention, e.g., a GB volatility index, and/or creating, listing, and trading derivative contracts that are based on an index of the present invention. A derivative contract of the present invention has a definition stored in module 202 that contains all relevant data concerning the derivative contract to be traded on the trading platform 120, including, for example, the contract symbol, a definition of the underlying asset or assets associated with the derivative, or a term of a calculation period associated with the derivative. A pricing data accumulation and dissemination module 204 receives contract information from the derivative contract definition module 202 and transaction data from the matching engine 110. The pricing data accumulation and dissemination module 204 provides the market data regarding open bids and offers and recent transactions to the market data vendors 118. The pricing data accumulation and dissemination module 204 also forwards transaction data to the Clearing Corporation 114 so that the Clearing Corporation 114 may mark-to-market the accounts of Member Firms at the close of each trading day, taking into account current market prices for the derivative contracts of the present invention. Finally, a settlement calculation module 206 receives input from the derivative monitoring module 208. On the settlement date the settlement calculation module 206 calculates the settlement amount based on the value associated with the underlying asset or assets, e.g., the value of a GB volatility index. The settlement calculation module 206 forwards the settlement amount to the Clearing Corporation 114, which performs a final mark-to-market on the Member Firms' accounts to settle the derivative contract of the present invention.

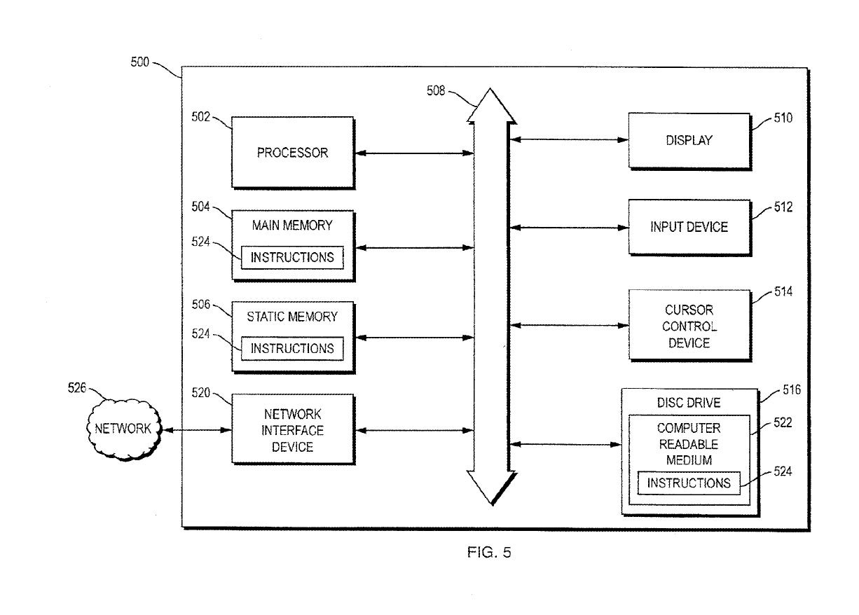

Referring to FIG. 5, an illustrative embodiment of a general computer system that may be used for one or more of the components shown in FIG. 1, or in any other trading system configured to carry out the methods discussed in further detail below, is shown and is designated 500. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 500 can also be implemented as or incorporated into various devices, such as a personal computer (“PC”), a tablet PC, a set-top box (“STB”), a personal digital assistant (“PDA”), a mobile device, a palmtop computer, a laptop computer, a desktop computer, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, such as a central processing unit (“CPU”), a graphics processing unit (“GPU”), or both. Moreover, the computer system 500 can include a main memory 504 and a static memory 506 that can communicate with each other via a bus 508. As shown, the computer system 500 may further include a video display unit 510, such as a liquid crystal display (“LCD”), an organic light emitting diode (“OLED”), a flat panel display, a solid state display, or a cathode ray tube (“CRT”). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g., software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture information communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols commonly used by investment management companies, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

According to one embodiment, systems and methods are provided for calculating and disseminating GB volatility indices. GB volatility indices (“GB-VI”) may be calculated and disseminated using the systems shown in FIGS. 1, 2, and 5 and described in detail above. Generally, the GB-VIs reflect the fair value of contracts for delivery of realized volatility of GB futures of arbitrary tenor, and reflect the expected volatility of GB futures prices within arbitrary investment horizons. The indexes may also be interpreted as the fair value of contracts for delivery of realized volatility of GB forwards, and reflect the expected volatility of GB forward prices within arbitrary investment horizons since realized and expected volatilities of futures and forwards are mathematically equivalent in the framework of the index design. According to some embodiments of the present invention, GB-VIs can be calculated for GB s in any country and currency for which bond futures (or forwards) and bond future (or forward) options markets exist. According to some embodiments of the present invention, the GB-VI is calculated based on data relating to a market for options on GB futures or forwards. For example, the GB-VIs would currently be particularly well suited for GB future (or forward) and GB future (or forward) option markets for bonds issued by the governments of the United States, Germany, United Kingdom, and Japan, among others.

According to some embodiments of the present invention, the GB-VIs are calculated for each maturity-tenor combination (i.e. maturity of the option and tenor of the bond underlying the future or forward underlying the option) on the “volatility surface,” by aggregating the price of at-the-money and out of-the money put and call options on bond futures (i.e., the option “skew,” the “volatility skew”), such as into a single formula, which may be independent of any option pricing model. These GB-VIs match the prevailing market practice of quoting volatility in interest rate markets in terms of either basis point price volatility or percentage price volatility. (Unless otherwise noted herein, any reference to volatility should be interpreted as price volatility and not yield volatility.) In addition, the GB-VIs may also be quoted in terms of basis point yield volatility (i.e. as opposed to price volatility),or modified duration-based basis point yield volatility, based on a model-free conversion from price volatility to yield volatility. Moreover, the GB-VIs described herein can reflect the fair market value of contracts for future delivery of GB volatility, at each point of the volatility surface, i.e., over any arbitrary maturity and underlying tenor.

Uncertainties relating to GB markets link to changes in the term structure of interest rates. Mathematically, the value of a coupon-bearing government bond, Bₜ(T_{N}), is,

$${B}_{t} ( {T}_{N} ) ≡ {\sum }_{i = {i}_{t}}^{N} \frac{{C}_{i}}{n} {P}_{t} ( {T}_{i} ) + {P}_{t} ( {T}_{N} )$$

where t is the valuation date; Tᵢ, i ∈[iₜ, N] are the coupon payment dates with T₁ being the first coupon payment after issuance at T₀, Tᵢ_{ₜ} being the first coupon date t, and T_{N} being the maturity of the bond when the last coupon payment is made with the repayment of principal; Cᵢ/N is the coupon payment at Tᵢ; and Pₜ(Tᵢ) is the price at time t of a zero coupon non-defaultable bond maturity at time Tᵢ and represents the main source of uncertainty in GB prices.

In a forward agreement for GBs, one party agrees to deliver to the other party a GB at a future date at a fixed price. The price of a forward, Fₜ(T,T_{N}), at time t for delivery at T of a bond maturing at T_{N} is given by

$${F}_{t} ( T , {T}_{N} ) = \frac{{B}_{t} ( {T}_{N} )}{{P}_{t} ( T )}$$

It may be that the contract allows the seller to choose from a set of multiple “deliverable” GBs, in which case the underlying bond, Bₜ(T_{N}), can be interpreted as the price tracking the “cheapest to deliver” GB and quoted in terms of either a traded flat price or an adjusted price based on some scalar “conversion factor.”

The forward price is a martingale under the “forward probability” Q_{F}_{^{T}} which is defined by

$${\frac{{dQ}_{{F}^{T}}}{dQ} \vert}_{{I}_{T}} = \frac{exp ( - {\int }_{t}^{T} r ( s ) ds )}{{P}_{t} ( T )}$$

where r(s) is the short-term rate at time s and I_{T} represents the set of information up to time T. Under the forward probability, the GB forward price dynamic satisfies

$$\frac{{dF}_{s} ( T , {T}_{N} )}{{F}_{s} ( T , {T}_{N} )} = {v}_{s} ( T , {T}_{N} ) {dW}_{{F}^{T}} ( s )$$

where W_{F}_{_{T}} (s) is a Brownian motion under Q_{F}_{^{T}} and vₛ(T,T_{N}) is the instantaneous volatility.

A “government bond variance swap agreement” is a contract in which party A agrees at time t to pay party B at time T the amount

Vₜ(T,T_{N})−S(t,T,T_{N}), T≤T_{N}

where Vₜ(T,T_{N})≡∫ₜ^{T}∥vₛ(T,T_{N})∥²ds and S(t,T,T_{N}) is the strike fixed at time t with fair value

$$S ( t , T , {T}_{N} ) = \frac{1}{{P}_{i} ( T )} {E}_{t} [ exp ( - {\int }_{t}^{T} {r}_{s} ds ) {V}_{t} ( T , {T}_{N} ) ] = {E}_{t}^{{Q}_{{F}^{T}}} [ {V}_{t} ( T , {T}_{N} ) ] - {E}_{t}^{{Q}_{{F}^{T}}} [ ln \frac{{F}_{T} ( T , {T}_{N} )}{{F}_{t} ( T , {T}_{N} )} ] = \frac{1}{2} {E}_{t}^{{Q}_{{F}^{T}}} [ {V}_{t} ( T , {T}_{N} ) ] = \frac{1}{2} S ( t , T , {T}_{N} )$$

where Eₜ is the expectation under the risk-neutral probability Q, and Eₜ^{Q}^{_{F}}^{T} is the expectation under the forward probability Q_{F}_{^{T}}, and both expectations are taken conditional on information up to time t. The last term is spanned by options with the following relationship

$${E}_{t}^{{Q}_{{F}^{T}}} [ ln \frac{{F}_{T} ( T , {T}_{N} )}{{F}_{t} ( T , {T}_{N} )} ] = - \frac{1}{{P}_{t} ( T )} [ {\int }_{0}^{{F}_{t} ( T , {T}_{N} )} \frac{{Put}_{t} ( K , T , {T}_{N} )}{{K}^{2}} dK + {\int }_{{F}_{t} ( T , {T}_{N} )}^{∞} \frac{{Call}_{t} ( K , T , {T}_{N} )}{{K}^{2}} dK ]$$

where Putₜ(t,T,T_{N}) is the price of a European-style put option with strike K and maturity T on a GB forward with maturity T and underlying bond tenor T_{N} and Callₜ(t,T,T_{N}) is the price of a European-style call option with strike K and maturity T on a GB forward with maturity T and underlying bond tenor T_{N}, which leads to the fair strike

$$S ( t , T , {T}_{N} ) = \frac{2}{{P}_{t} ( T )} [ {\int }_{0}^{{F}_{t} ( T , {T}_{N} )} \frac{{Put}_{t} ( K , T , {T}_{N} )}{{K}^{2}} dK + {\int }_{{F}_{t} ( T , {T}_{N} )}^{∞} \frac{{Call}_{t} ( K , T , {T}_{N} )}{{K}^{2}} dK ]$$

In practice, there is a finite set of strike rates traded at any given moment and therefore the integrals will be replaced by discrete finite sums:

$$S ( t , T , {T}_{N} ) ≡ \frac{2}{{P}_{t} ( T )} [ {\sum }_{i : {K}_{i} < {F}_{t} ( T , {T}_{N} )} \frac{{Put}_{t} ( {K}_{i} , T , {T}_{N} )}{{K}_{i}^{2}} Δ {K}_{i} + {\sum }_{i : {K}_{i} < {F}_{t} ( T , {T}_{N} )} \frac{{Call}_{t} ( {K}_{i} , T , {T}_{N} )}{{K}_{i}^{2}} Δ {K}_{i} ]$$

where K₀ denotes the lowest strike of the Z+1 options; Kᵢ denotes the i^{th} highest strike of the Z+1 options; K_{Z} denotes the highest strike of the Z+1 options; and ΔKᵢ=1/2(Kᵢ₊₁−Kᵢ₋₁) for i≥1, and ΔK₀=(K₁−K₀), ΔK_{Z}=(K_{Z}−K_{Z-1}).

In some embodiments, a “Percentage Government Bond Price Volatility Index” is expressed as:

$$Eq . ( PCT\_GBVI )$$

$$GB - VI ( t , T , {T}_{N} ) ≡ 100 \times \sqrt{\frac{S ( t , T , {T}_{N} )}{T - t}} \\ Continuous Case \text{:} \\ = 100 \times \sqrt{\frac{2}{{P}_{t} ( T ) ( T - t )} [ {\int }_{0}^{{F}_{t} ( T , {T}_{N} )} \frac{{Put}_{t} ( K , T , {T}_{N} )}{{K}^{2}} dk + {\int }_{{F}_{t} ( T , {T}_{N} )}^{∞} \frac{{Call}_{t} ( K , T , {T}_{N} )}{{K}^{2}} dK ]} \\ Discrete Case \text{:} \\ = 100 \times \sqrt{\frac{2}{{P}_{t} ( T ) ( T - t )} [ \begin{matrix}{\sum }_{i : {K}_{i} < {F}_{t} ( T , {T}_{N} )} \frac{{Put}_{t} ( {K}_{i} , T , {T}_{N} )}{{K}_{i}^{2}} Δ {K}_{i} + \\ {\sum }_{i : {K}_{i} \geq {F}_{t} ( T , {T}_{N} )} \frac{{Call}_{t} ( {K}_{i} , T , {T}_{N} )}{{K}_{i}^{2}} Δ {K}_{i}\end{matrix} ]} \\ Discrete Case with Forward Adjustment \text{:} \\ = 100 \times \sqrt{\frac{1}{( T - t )} [ \frac{2}{{P}_{t} ( T )} [ \begin{matrix}{\sum }_{i : {K}_{i} < {K}_{*}} \frac{{Put}_{t} ( {K}_{i} , T , {T}_{N} )}{{K}_{i}^{2}} Δ {K}_{i} + \\ {\sum }_{i : {K}_{i} \geq {K}_{*}} \frac{{Call}_{t} ( {K}_{i} , T , {T}_{N} )}{{K}_{i}^{2}} Δ {K}_{i}\end{matrix} ] - {( \frac{{F}_{t} ( T , {T}_{N} )}{{K}_{*}} )}^{2} ]}$$

where the forward adjustment handles the case in which there is no option struck at the ATM forward price and K* is the first available strike below the current forward price Fₜ(T,T_{N}). If the forward price is not observable at time t, then Fₜ(T,T_{N}) is the strike at which the difference between the put and call prices is smallest.

More generally for any constant multiplier CM

$$GB - VI ( t , T , {T}_{N} ) ≡ CM \times \sqrt{\frac{S ( t , T , {T}_{N} )}{T - t}}$$

$$Continuous Case \text{:} \\ = CM \times \sqrt{\frac{2}{{P}_{i} ( T ) ( T - t )} [ \begin{matrix}{\int }_{0}^{{F}_{t} ( T , {T}_{N} )} \frac{{Put}_{t} ( K , T , {T}_{N} )}{{K}^{2}} dK + \\ {\int }_{{F}_{t} ( T , {T}_{N} )}^{∞} \frac{{Call}_{t} ( K , T , {T}_{N} )}{{K}^{2}} dK\end{matrix} ]}$$

$$Discrete Case \text{:} \\ = CM \times \sqrt{\frac{2}{{P}_{t} ( T ) ( T - t )} [ \begin{matrix}{\sum }_{i : {K}_{i} < {F}_{t} ( T , {T}_{N} )} \frac{{Put}_{t} ( {K}_{i} , T , {T}_{N} )}{{K}_{i}^{2}} Δ {K}_{i} + \\ {\sum }_{i : {K}_{i} \geq {F}_{t} ( T , {T}_{N} )} \frac{{Call}_{t} ( {K}_{i} , T , {T}_{N} )}{{K}_{i}^{2}} Δ {K}_{i}\end{matrix} ]}$$

$$Discrete Case with Forward Adjustment \text{:} \\ = CM \times \sqrt{\frac{1}{( T - t )} [ \frac{2}{{P}_{t} ( T )} [ \begin{matrix}{\sum }_{i : {K}_{i} < {K}_{*}} \frac{{Put}_{t} ( {K}_{i} , T , {T}_{N} )}{{K}_{i}^{1}} Δ {K}_{i} + \\ {\sum }_{i : {K}_{i} \geq {K}_{*}} \frac{{Call}_{t} ( {K}_{i} , T , {T}_{N} )}{{K}_{i}^{2}} Δ {K}_{i}\end{matrix} ] - {( \frac{{F}_{t} ( T , {T}_{N} ) - {K}_{*}}{{K}_{*}} )}^{2} ]}$$

which is a scaled fair value of the GB variance swap agreement.

The above contract designs and index formulas are also extended for options on GB forwards with a later expiry than the option, for example:

$$GB - VI ( t , T , {T}_{D} , {T}_{N} ) ≡ 100 \times \sqrt{\frac{1}{( T - t )} [ \frac{2}{{P}_{t} ( T )} [ \begin{matrix}{\sum }_{i : {K}_{i} < {K}_{*}} \frac{{Put}_{t} ( {K}_{i} , T , {T}_{D} , {T}_{N} )}{{K}_{i}^{2}} Δ {K}_{i} + \\ {\sum }_{i : {K}_{i} \geq {K}_{*}} \frac{{Call}_{t} ( {K}_{i} , T , {T}_{D} , {T}_{N} )}{{K}_{i}^{2}} Δ {K}_{i}\end{matrix} ] - {( \frac{{F}_{t} ( {T}_{D} , {T}_{N} ) - {K}_{*}}{{K}_{*}} )}^{2} ]}$$

where T_{D} denotes a time of maturity of the government bond forward underlying the options maturity at T where T_{D}≥T. K* is the first available strike below the current forward price Fₜ(T_{D},T_{N}). If the forward price is not observable at time t, then Fₜ(T_{D},T_{N}) is the strike at which the difference between the put and call prices is smallest.

A “government bond basis point variance swap agreement” is a contract in which party A agrees at time t to pay party B at time T the amount

Vₜ^{bp}(T,T_{N})−S^{bp}(t,T,T_{N}), T≤T_{N}

where Vₜ^{bp}(T,T_{N})≡∫ₜ^{T}Fₛ²(T,T_{N})∥vₛ(T,T_{N})∥²ds and S^{bp}(t,T,T_{N}) is the strike fixed at time t with fair value

S^{bp}(t,T,T_{N})=Eₜ^{Q}^{_{F}}^{T}[Vₜ^{bp}(T,T_{N})]=Eₜ^{Q}^{_{F}}^{T}[F_{T}²(T,T_{N})]−Fₜ²(T,T_{N})

where Eₜ^{Q}^{_{F}}^{T} is the expectation under probability Q_{F}_{^{T}} conditional on information up to time t. The last term is spanned by options with the following relationship

$${E}_{t}^{{Q}_{{F}^{T}}} [ {F}_{T}^{2} ( T , {T}_{N} ) ] - {F}_{t}^{2} ( T , {T}_{N} ) = \frac{2}{{P}_{t} ( T )} [ {\int }_{0}^{{F}_{t} ( T , {T}_{N} )} {Put}_{t} ( K , T , {T}_{N} ) dK + {\int }_{{F}_{t} ( T , {T}_{N} )}^{∞} {Call}_{t} ( K , T , {T}_{N} ) dK ]$$

where Putₜ(t,T,T_{N}) is the price of a European-style put option with strike K and maturity T on a GB forward with maturity T and underlying bond tenor T_{N} and Callₜ(t,T,T_{N}) is the price of a European-style call option with strike K and maturity T on a GB forward with maturity T and underlying bond tenor T_{N}, which leads to the fair strike

$${S}^{bp} ( t , T , {T}_{N} ) = \frac{2}{{P}_{t} ( T )} [ {\int }_{0}^{{F}_{t} ( T , {T}_{N} )} {Put}_{i} ( K , T , {T}_{N} ) dK + {\int }_{{F}_{t} ( T , {T}_{N} )}^{∞} {Call}_{t} ( K , T , {T}_{N} ) dK ]$$

In practice, there is a finite set of strike rates traded at any given moment and therefore the integrals will be replaced by discrete finite sums:

$${S}^{bp} ( t , T , {T}_{N} ) ≡ \frac{2}{{P}_{t} ( T )} [ {\sum }_{i : {K}_{i} < {F}_{t} ( T , {T}_{N} )} {Put}_{t} ( {K}_{i} , T , {T}_{N} ) Δ {K}_{i} + {\sum }_{i : {K}_{i} \geq {F}_{t} ( T , {T}_{N} )} {Call}_{t} ( {K}_{i} , T , {T}_{N} ) Δ {K}_{i} ]$$

In some embodiments, a “Basis Point Government Bond Price Volatility Index” is expressed as:

$$Eq . ( BP\_GBVI )$$

$$GB - {VI}^{bp} ( t , T , {T}_{N} ) ≡ 100 \times 100 \times \sqrt{\frac{{S}^{bp} ( t , T , {T}_{N} )}{T - t}} \\ Continuous case \text{:} \\ = {100}^{2} \times \sqrt{\frac{2}{{P}_{t} ( T ) ( T - t )} [ {\int }_{0}^{{F}_{t} ( T , {T}_{N} )} {Put}_{t} ( K , T , {T}_{N} ) dK + {\int }_{{F}_{t} ( T , {T}_{N} )}^{∞} {Call}_{t} ( K , T , {T}_{N} ) dK ]} \\ Discrete Case \text{:} \\ = {100}^{2} \times \sqrt{\frac{2}{{P}_{t} ( T ) ( T - t )} [ \begin{matrix}{\sum }_{i : {K}_{i} < {F}_{t} ( T , {T}_{N} )} {Put}_{t} ( {K}_{i} , T , {T}_{N} ) Δ {K}_{i} + \\ {\sum }_{i : {K}_{i} \geq {F}_{t} ( T , {T}_{N} )} {Call}_{t} ( {K}_{i} T , {T}_{N} ) Δ {K}_{i}\end{matrix} ]} \\ Discrete Case with Forward Adjustment \text{:} \\ = {100}^{2} \times \sqrt{\frac{1}{( T - t )} [ \frac{2}{{P}_{t} ( T )} [ \begin{matrix}{\sum }_{i : {K}_{i} < {K}_{*}} {Put}_{t} ( {K}_{i} , T , {T}_{N} ) Δ {K}_{i} + \\ {\sum }_{i : {K}_{i} \geq {K}_{*}} {Call}_{t} ( {K}_{i} , T , {T}_{N} ) Δ {K}_{i}\end{matrix} ] - {( {F}_{t} ( T , {T}_{N} ) - {K}_{*} )}^{2} ]}$$

which is a scaled fair value of the BP GB variance swap agreement.

More generally for any constant multiplier CM

$$GB - {VI}^{bp} ( t , T , {T}_{N} ) ≡ CM \times \sqrt{\frac{{S}^{bp} ( t , T , {T}_{N} )}{T - t}}$$

$$Continuous case \text{:} \\ = CM \times \sqrt{\frac{2}{{P}_{t} ( T ) ( T - t )} [ {\int }_{0}^{{F}_{t} ( T , {T}_{N} )} {Put}_{i} ( K , T , {T}_{N} ) dK + {\int }_{{F}_{t} ( T , {T}_{N} )}^{∞} {Call}_{t} ( K , T , {T}_{N} ) dK ]}$$

$$Discrete Case \text{:} \\ = CM \times \sqrt{\frac{2}{{P}_{t} ( T ) ( T - 1 )} [ \begin{matrix}{\sum }_{i : {K}_{i} < {F}_{t} ( T , {T}_{N} )} {Put}_{t} ( {K}_{i} , T , {T}_{N} ) Δ {K}_{i} + \\ {\sum }_{i : {K}_{i} \geq {F}_{t} ( T , {T}_{N} )} Call , ( {K}_{i} , T , {T}_{N} ) Δ {K}_{i}\end{matrix} ]}$$

$$Discrete Case with Forward Adjustment \text{:} \\ = CM \times \sqrt{\frac{1}{( T - 1 )} [ \frac{2}{{P}_{t} ( T )} [ \begin{matrix}{\sum }_{i : {K}_{i} < {K}_{*}} {Put}_{t} ( {K}_{i} , T , {T}_{N} ) Δ {K}_{i} + \\ {\sum }_{i : {K}_{i} \geq {K}_{*}} {Call}_{t} ( {K}_{i} , T , {T}_{N} ) Δ {K}_{i}\end{matrix} ] - {( {F}_{t} ( T , {T}_{N} ) - {K}_{*} )}^{2} ]}$$

The above contract designs and index formulas are also extended for options on GB forwards with a later expiry than the option, for example:

$$GB - {VI}^{bp} ( t , T , {T}_{D} , {T}_{N} ) ≡ {100}^{2} \times \sqrt{\frac{1}{( T - t )} [ \frac{2}{{P}_{t} ( T )} [ \begin{matrix}{\sum }_{i : {K}_{i} < {K}_{*}} {Put}_{t} ( {K}_{i} , T , {T}_{D} , {T}_{N} ) Δ {K}_{i} + \\ {\sum }_{i : {K}_{i} \geq {K}_{*}} {Call}_{t} ( {K}_{i} , T , {T}_{D} , {T}_{N} ) Δ {K}_{i}\end{matrix} ] - {( {F}_{t} ( {T}_{D} , {T}_{N} ) - {K}_{*} )}^{2} ]}$$

where T_{D} denotes a time of maturity of the government bond forward underlying the options maturing at T where T_{D}≥T. K* is the first available strike below the current forward price Fₜ(T_{D},T_{N}). If the forward price is not observable at time t, then Fₜ(T_{D},T_{N}) is the strike at which the difference between the put and call prices is smallest.

While volatility in the GB market is most commonly measured and traded in terms of price volatility, an additional formulation of GB bond futures volatility—basis point yield volatility—is also considered.

Define the implied bond price B*(T_{N}) such that

GB-VI^{bp}(t,T,T_{N})=B*(T_{N})×GB-VI(t,T,T_{N})

and its corresponding yield y_{B}(T_{N}) such that

$$GB - {VI}_{Y}^{bp} ( t , T , {T}_{N} ) = 100 \times {y}_{{B}_{*}} ( {T}_{N} ) \times GB - VI ( t , T , {T}_{N} )$$

$${y}_{{B}_{*}} ( {T}_{N} ) \text{:} {B}_{*} ( {T}_{N} ) = \frac{GB - {VI}^{bp} ( t , T , {T}_{N} )}{GB - VI ( t , T , {T}_{N} )} = \hat{P} ( {y}_{{B}_{*}} ( {T}_{N} ) )$$

$$and$$

$$\hat{P} ( y ) ≡ {\sum }_{i = 1}^{N} \frac{{C}_{i}}{n} {( 1 + \frac{y}{n} )}^{- i} + 100 {( 1 + \frac{y}{n} )}^{- N}$$

or in the presence of accrued coupons at time T with the next coupon due at tⱼ,

$${\hat{P}}_{T} ( x ) ≡ {\sum }_{i = j}^{N} \frac{{C}_{i}}{n} {( 1 + x )}^{- \frac{d c ( {t}_{i} - T )}{d c ( year )}} + 100 {( 1 + x )}^{- \frac{d c ( {t}_{N} - T )}{d c ( year )}}$$

where dc(year) is the number of days in a year based on a day count convention used for the government bond, and dc(T-t) is the number of days between t and T based on a day count convention used for the government bond.

Then in some embodiments, the “Basis Point Government Bond Yield Volatility Index” may be expressed as

$$GB - {VI}_{Y}^{bp} ( t , T , {T}_{N} ) ≡ 100 \times {\hat{P}}^{- 1} [ \frac{GB - {VI}^{bp} ( t , T , {T}_{N} )}{GB - VI ( t , T , {T}_{N} )} ] \times GB - VI ( t , T , {T}_{N} )$$

or in the presence of accrued coupons at time T with the next coupon due at tⱼ,

$$GB - {VI}_{Y}^{bp} ( t , T , {T}_{N} ) ≡ 100 \times {\hat{P}}_{T}^{- 1} [ \frac{GB - {VI}^{bp} ( t , T , {T}_{N} )}{GB - VI ( t , T , {T}_{N} )} ] \times GB - VI ( t , T , {T}_{N} ) \qquad Eq . ( BPY\_GBVI )$$

Where \hat{P}⁻¹(y) is the functional inverse of \hat{P}(y) and \hat{P}_{T}⁻¹(x) is the functional inverse of \hat{P}_{T}(x).

The above index formula are also extended for options on GB forwards with a later expiry than the option, for example:

$$GB - {VI}_{Y}^{bp} ( t , T , {T}_{D} , {T}_{N} ) ≡ 100 \times {\hat{P}}^{- 1} [ \frac{GB - {VI}^{bp} ( t , T , {T}_{D} , {T}_{N} )}{GB - VI ( t , T , {T}_{D} , {T}_{N} )} ] \times GB - VI ( t , T , {T}_{D} , {T}_{N} )$$

$$and$$

$$GB - {VI}_{Y}^{bp} ( t , T , {T}_{D} , {T}_{N} ) ≡ 100 \times {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] \times GB - VI ( t , T , {T}_{D} , {T}_{N} )$$

where T_{D} denotes a time of maturity of the government bond forward underlying the options maturing at T where T_{D}≥T.

In some embodiments, the “Modified Duration-Based Basis Point Government Bond Yield Volatility Index” may be defined as:

$$E q . ( MDBPY\_GBVI )$$

$$GB - {VI}_{Yd}^{bp} ( t , T , {T}_{D} , {T}_{N} ) ≡ \frac{\begin{matrix}100 \times ( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] ) \times \\ GB - {VI}^{bp} ( t , T , {T}_{D} , {T}_{N} )\end{matrix}}{\begin{matrix}{\sum }_{i = j}^{N} \frac{{C}_{i}}{n} {( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] )}^{- \frac{d c ( {t}_{i} - T )}{d c ( year )}} ( \frac{d c ( {t}_{i} - T )}{d c ( year )} ) + \\ 100 {( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] )}^{- \frac{d c ( {t}_{N} - T )}{d c ( year )}} ( \frac{d c ( {t}_{N} - T )}{d c ( year )} )\end{matrix}}$$

with notation as defined in the above paragraph.

For PCT_GBVI, BP_GBVI, BPY_GBVI, and MDBPY_GBVI, when the maturity of the options are shorter than the underlying GB forward, T<T_{D}, one may compute an adjustment term to account for the effect of the difference in maturities. The four adjusted index formulas are as follows:

$$GB - {VI}_{adj} ( t , T , {T}_{D} , {T}_{N} ) ≡ 100 \times \sqrt{\frac{( T - t ) \times {( GB - VI ( t , T , {T}_{D} , {T}_{N} ) / 100 )}^{2} + C ( t , T , {T}_{D} , {T}_{N} )}{T - t}}$$

$$GB - {VI}_{adj}^{bp} ( t , T , {T}_{D} , {T}_{N} ) ≡ {100}^{2} \times \sqrt{\frac{( T - t ) \times {( GB - {VI}^{bp} ( t , T , {T}_{D} , {T}_{N} ) / {100}^{2} )}^{2} + {C}^{bp} ( t , T , {T}_{D} , {T}_{N} )}{T - t}}$$

$$GB - {VI}_{Y , adj}^{bp} ( t , T , {T}_{D} , {T}_{N} ) ≡ 100 \times {\hat{P}}_{T}^{- 1} [ \frac{GB - {VI}_{adj}^{bp} ( t , T , {T}_{D} , {T}_{N} )}{GB - {VI}_{adj} ( t , T , {T}_{D} , {T}_{N} )} ] \times GB - {VI}_{adj} ( t , T , {T}_{D} , {T}_{N} )$$

$$GB - {VI}_{Yd , adj}^{bp} ( t , T , {T}_{D} , {T}_{N} ) ≡ \frac{\begin{matrix}100 \times ( 1 + {\hat{P}}_{T}^{- 1} [ \frac{GB - {VI}_{adj}^{bp} ( t , T , {T}_{D} , {T}_{N} )}{GB - {VI}_{adj} ( t , T , {T}_{D} , {T}_{N} )} ] ) \times \\ GB - {VI}_{adj}^{bp} ( t , T , {T}_{D} , {T}_{N} )\end{matrix}}{\begin{matrix}{\sum }_{i = j}^{N} \frac{{C}_{i}}{n} {( 1 + {\hat{P}}_{T}^{- 1} [ \frac{GB - {VI}_{adj}^{bp} ( t , T , {T}_{D} , {T}_{N} )}{GB - {VI}_{adj} ( t , T , {T}_{D} , {T}_{N} )} ] )}^{- \frac{d c ( {t}_{i} - T )}{d c ( year )}} ( \frac{d c ( {t}_{i} - T )}{d c ( year )} ) + \\ 100 {( 1 + {\hat{P}}_{T}^{- 1} [ \frac{GB - {VI}_{adj}^{bp} ( t , T , {T}_{D} , {T}_{N} )}{GB - {VI}_{adj} ( t , T , {T}_{D} , {T}_{N} )} ] )}^{- \frac{d c ( {t}_{N} - T )}{d c ( year )}} ( \frac{d c ( {t}_{N} - T )}{d c ( year )} )\end{matrix}}$$

$$where$$

$$C ( t , T , {T}_{D} , {T}_{N} ) ≡ 2 ( {\int }_{0}^{{F}_{t} ( {T}_{D} , {T}_{N} )} {C}_{1 t} ( K , T , {T}_{D} , {T}_{N} ) \frac{1}{{K}^{2}} dK + {\int }_{{F}_{t} ( {T}_{D} , {T}_{N} )}^{∞} {C}_{2 t} ( K , T , {T}_{D} , {T}_{N} ) \frac{1}{{K}^{2}} dK ) - {C}_{0 t} ( T , {T}_{D} , {T}_{N} )$$

$${C}^{bp} ( t , T , {T}_{D} , {T}_{N} ) ≡ 2 ( {\int }_{0}^{{F}_{t} ( {T}_{D} , {T}_{N} )} {C}_{1 t} ( K , T , {T}_{D} , {T}_{N} ) dK + {\int }_{{F}_{t} ( {T}_{D} , {T}_{N} )}^{∞} {C}_{2 t} ( K , T , {T}_{D} , {T}_{N} ) dK ) - {C}_{0 t}^{bp} ( T , {T}_{D} , {T}_{N} )$$

$${C}_{0 t} ( K , T , {T}_{D} , {T}_{N} ) ≡ {Cov}_{t}^{{Q}_{{F}^{T}}} ( {V}_{t} ( T , {T}_{D} , {T}_{N} ) , \frac{{P}_{t} ( T )}{{P}_{t} ( {T}_{D} )} {e}^{- {\int }_{T}^{{T}_{D}} {r}_{s} ds} )$$

$${C}_{0 t}^{bp} ( K , T , {T}_{D} , {T}_{N} ) ≡ {Cov}_{t}^{{Q}_{{F}^{T}}} ( {V}_{t}^{bp} ( T , {T}_{D} , {T}_{N} ) , \frac{{P}_{t} ( T )}{{P}_{t} ( {T}_{D} )} {e}^{- {\int }_{T}^{{T}_{D}} {rt}_{s} ds} )$$

$${C}_{1 t} ( K , T , {T}_{D} , {T}_{N} ) ≡ {Cov}_{t}^{{Q}_{{F}^{T}}} ( K - {{F}_{T} ( {T}_{D} , {T}_{N} )}^{+} , \frac{{P}_{t} ( T )}{{P}_{t} ( {T}_{D} )} {e}^{- {\int }_{T}^{{T}_{D}} {r}_{s} ds} )$$

$${C}_{2 t} ( K , T , {T}_{D} , {T}_{N} ) ≡ {Cov}_{t}^{{Q}_{{F}^{T}}} ( {( {F}_{T} ( {T}_{D} , {T}_{N} ) - K )}^{+} , \frac{{P}_{t} ( T )}{{P}_{t} ( {T}_{D} )} {e}^{- {\int }_{T}^{{T}_{D}} {r}_{s} ds} )$$

$${V}_{t} ( T , {T}_{D} , {T}_{N} ) ≡ {\int }_{t}^{T} {‖ {v}_{s} ( {T}_{D} , {T}_{N} ) ‖}^{2} ds$$

$${V}_{t}^{bp} ( T , {T}_{D} , {T}_{N} ) ≡ {\int }_{t}^{T} {F}_{s}^{2} ( {T}_{D} , {T}_{N} ) {‖ {v}_{s} ( {T}_{D} , {T}_{N} ) ‖}^{2} ds \\ GB - {VI}_{adj}^{bp} ( t , T , {T}_{D} , {T}_{N} ) = {B}_{{*}_{, adj}} ( t , T , {T}_{D} , {T}_{N} ) \times GB - {VI}_{adj} ( t , T , {T}_{D} , {T}_{N} )$$

and C₀ₜ, C₀ₜ^{bp}, C₁ₜ, C₂ₜ may be calculated based on a specification of interest rate dynamics.

In the absence of prices for options struck at-the-money, GB-VI_{adj} may further be adjusted by replacing C(t,T,T_{D},T_{N}) with

$$C ( t , T , {T}_{D} , {T}_{N} ) - {( \frac{{F}_{t} ( {T}_{D} , {T}_{N} ) - {K}_{*}}{{K}_{*}} )}^{2}$$

and replacing Fₜ(T_{D},T_{N}) by K* in all of the integration (or summation in discrete case) limits in the index formula where K* is the first strike below Fₜ(T_{D},T_{N}). Similarly, GB-VI_{adj}^{bp}, may further be adjusted by replacing C^{bp}(t,T,T_{D},T_{N}) with C^{bp}(t,T,T_{D},T_{N})−(Fₜ(T_{D},T_{N})−K*)² and replacing Fₜ(T_{D},T_{N}) by K* in all of the integration (or summation in discrete case) limits in the index formula where K* is the first strike below Fₜ(T_{D},T_{N}). In turn, the strike-adjusted versions of GB-VI_{adj} and GB-VI_{adj}^{bp} may be used to calculate GB-VI_{Y,adj}^{bp} and GB-VI_{Yd,adj}^{bp} in the absence of an ATM option price.

The mathematical exposition and formulas given above for Government Bond Volatility Indexes employ prices of European-style options on GB forwards. However, options with other exercise styles or options with other underlying GB derivatives may also be used directly in the above formulas if it is determined that the prices of such options are not materially different from equivalent prices of European-style options on GB forwards. For example, prices of out-of-the-money American-style options on Government Bond futures are likely to not be materially different from otherwise-equivalent European-style options on Government Bond forwards, as one may conclude from the work of Flesaker, B. 1993, “Testing the Heath-Jarrow-Morton/Ho-Lee Model of Interest Rate Contingent Claims Pricing” Journal of Financial and Quantitative Analysis 28, and Bikbov, R. and M. Chernov, 2011, “Yield Curve and Volatility: Lessons from Eurodollar Futures and Options” Journal of Financial Econometrics 9.

Current practice on some exchanges is to list American-style options on GB futures. In case there arises a situation in which prices of American-style options on GB futures materially differ from European-style options on GB forwards, the inventors have developed techniques for converting American bond future option prices to corresponding European bond forward option prices, which may be performed by (1) choosing a model of interest rate dynamics and estimate its parameters using historical data; (2) defining and calibrating the price of risk such that the difference between the observed option prices and the option prices implied by the model in (1) is minimized; and using the calibrated price of risk in (2) to calculate the model-implied European options on government bond forwards.

In one example technique, prices of American-style options on government bond futures may be transformed into prices of European-style options on government bond forwards. This example technique is performed as follows:
Step 1. Choose the Vasicek (1977) model of interest rates

drₜ=κ(μ−rₜ)dt+σdWₜ^{P}

where rₜ is the instantaneous interest rate at time t and Wₜ^{P} is a Brownian motion under the physical probability measure P. The parameters are to be estimated (κ, μ, σ) using historical interest rate data.
Step 2 Define the risk-neutral dynamics of the short-term rate as follows:

$${dr}_{t} = κ ( \overline{r} - {r}_{t} ) dt + σ {dW}_{t} , \overline{r} ≡ μ - \frac{λ σ}{κ}$$

where Wₜ is a Brownian motion under the risk neutral probability measure, and λ is the price of risk. Calibrate the price of risk by finding \hat{λ} either by solving minimization problem 2A or 2B: Minimization problem 2A:

$$\hat{λ} = arg {min}_{λ ∈ Λ} {\sum }_{j = 1}^{M} {( {O}^{model} ( {K}_{j} ; λ ) - {O}^{market} ( {K}_{j} ) )}^{2} w ( {K}_{j} )$$

where Λ is a compact set; K is the option strike; O^{model} (K; λ) is the model-implied option price with strike K and price of risk λ; O^{market} (K) is the observed option price with strike K; and w(K) is a weighting function; and M denotes the number of observable option prices. Minimization problem 2B:

For each strike K, find \hat{λ} such that the model-implied option price O^{model} (K; \hat{λ}) exactly matches the observed option price O^{market}(K), which leads to a skew of risk premiums defined by the function \hat{λ}(K) such that O^{model}(K; \hat{λ}(K))=O^{market}(K) for each K.

In both 2A and 2B, the model price of American-style options on government bond futures, O^{model}(K; λ), is O^{model}(K; λ)≡Cₛ(rₛ; K)|ₛ₌ₜ where Cₛ(rₛ; K) is the recursive solution to Cₛ(rₛ; K)=max{ψ(\tilde{F}ₛ(rₛ; T,T_{N})), exp(−rₛΔₛ)E[C_{s1Δ}_{ₛ}(r_{s1Δ}_{ₛ}; K)[}

where the payoff is ψ(\tilde{F}ₛ)=\tilde{F}ₛ−K for a call option and ψ(\hat{F}ₛ)=K−\hat{F}ₛ for a put option; Δₛ is the incremental time after time s at which time the option may be exercised; E is the expectation under the risk neutral probability measure; and the futures price \hat{F}ₛ(rₛ; T,T_{N}) is calculated according to the formula

$${\tilde{F}}_{t} ( {r}_{t} T , {T}_{N} ) = {E}_{t} [ {B}_{T} ( {r}_{T} , {T}_{N} ) ] {\sum }_{i = {i}_{t}}^{N} {\overline{C}}_{i} \times exp ( {a}_{t}^{F} ( T , {T}_{i} ) - {b}_{t}^{F} ( T , {T}_{i} ) {r}_{i} )$$

$${\overline{C}}_{i} ≡ {C}_{i} / N , i = 1 , … , N - 1 , {C}_{N} = 1 + {C}_{N} / N$$

$${a}_{t}^{F} ( T , {T}_{i} ) ≡ {a}_{T} ( {T}_{i} ) - ( 1 - exp ( - κ ( T - t ) ) ) \overline{r} {b}_{T} ( {T}_{i} ) + ( {σ}^{2} ( 1 - exp ( - 2 κ ( T - t ) ) ) {b}_{T}^{2} ( {T}_{i} ) / 4 κ \\ {b}_{t}^{F} ( T , {T}_{i} ) ≡ exp ( - κ ( T - t ) {b}_{T} ( {T}_{i} ) ) \\ {a}_{t} ( T ) ≡ ( \frac{1 - exp ( - κ ( T - t ) )}{κ} - ( T - t ) ) ( \overline{r} - \frac{1}{2} {( \frac{σ}{κ} )}^{2} ) - \frac{{σ}^{2}}{4 {κ}^{3}} {( 1 - exp ( - κ ( T - t ) ) )}^{2} \\ {b}_{t} ( T ) ≡ \frac{1}{κ} ( 1 - exp ( - κ ( T - t ) ) )$$

Step 3. Use the \hat{λ} in case of 2A and \hat{λ}(Kᵢ) in the case of 2B to calculate prices of European options on government bond forwards using the Jamshidian (1989) formula

$${Call}_{t} ( K , T , {T}_{N} ) = {{\sum }_{i = 1}}^{N} \overline{{C}_{i}} \times \overline{{Call}_{t}} ( T ; {P}_{t} ( {T}_{i} ) , {K}_{i}^{*} ( K ) , {υ}_{i} )$$

$$and$$

$${Put}_{t} ( K , T , {T}_{N} ) = {Call}_{t} ( K , T , {T}_{N} ) + {P}_{t} ( T ) K - {B}_{t} ( {T}_{N} )$$

$$where$$

$${K}_{i}^{*} ( K ) = {P}_{T} ( {r}^{*} ( K ) , {T}_{i} )$$

$$\overline{{Call}_{t}} ( T ; {P}_{t} ( {T}_{i} ) , {K}_{i}^{*} ( K ) , {υ}_{i} ) = {P}_{i} Φ ( {d}_{1 , i} ) - {K}_{i}^{*} ( K ) {P}_{t} ( T ) Φ ( {d}_{1 , i} - {υ}_{i} )$$

$${d}_{1 , i} = \frac{ln \frac{P}{{K}_{i}^{*} ( K ) {P}_{t} ( T )} + \frac{1}{2} {υ}_{i}^{2}}{{υ}_{i}} , {υ}_{i} = σ \sqrt{\frac{1 - exp ( - 2 κ ( T - t ) )}{2 κ}} {b}_{T} ( {T}_{i} )$$

$${P}_{t} ( r , T ) = exp ( {a}_{i} ( T ) - {b}_{t} ( T ) r , {B}_{t} ( {r}_{t} , T ) ≡ {\sum }_{i = 1}^{N} \overline{{C}_{i}} {P}_{t} ( {r}_{t} , {T}_{i} )$$

and r* (K) is such that B_{T}(r*(K),T_{N})=K.

In the case of 2B, in order to use risk-premiums calibrated to future options in a formula for options on forwards, the risk-premium skew, \hat{λ}(Kᵢ), is tilted to \hat{λ}(Kᵢ**) by the transformation

$${K}_{i}^{**} = {K}_{i} \frac{{F}_{t} ( {r}_{t} ; T , {T}_{N} )}{{\tilde{F}}_{t}^{\$} ( T , {T}_{N} )}$$

where Fₜ(rₜ;T,T_{N}) is the model-based forward price and \tilde{F}ₜ^{$}(T,T_{N})is the market future price. The forward price Fₜ(rₜ; T,T_{N}) is calculated using \hat{λ}(Kₐₜₘ**) where Kₐₜₘ**=Fₜ(rₜ; T,T_{N}) is found through the fixed-point problem:

\hat{λ}⁽ⁱ⁾=\hat{λ}(Fₜ⁽ⁱ⁾), Fₜ⁽ⁱ⁺¹⁾=Fₜ(rₜ; T,T_{N}; \hat{λ}⁽ⁱ⁾) \hat{λ}⁽⁰⁾=initial guess

and Fₜ(rₜ; T,T_{N}; \hat{λ}⁽ⁱ⁾) is the forward price predicted by the model when the risk-premium is equal to \hat{λ}⁽ⁱ⁾.

For GB forward and forward options markets that trade in cycles based on standardized roll dates (e.g. quarterly rolls in March, June, September, December), two or more forward options with varying maturities may be used in combination to calculate an index with a maturity corresponding to any maturity in between the shortest and longest maturities used. The same methodology may be used in the case of GB futures and future options.

In the case where GB forward and forward options trade with maturity cycles, as a first non-limiting example, the index may be calculated with the nearest and next roll dates using a “sandwich combination” such that a volatility index with an m month horizon is calculated as

$${I}_{t} ≡ \sqrt{\frac{1}{( m / 12 )} [ {x}_{t} {V}_{t} ( {T}_{i} ) + ( 1 - {x}_{t} ) {V}_{t} ( {T}_{i + 1} ) ]} , t ∈ [ {T}_{i - 1} , {T}_{i} ]$$

where Tᵢ−Tᵢ₋₁=Tᵢ₊₁−Tᵢ=m×d and Tᵢ₊₁−Tᵢ₋₁=2m×d; d is the number of days in a month; Vₜ(Tᵢ) is equal to S(t,T,T_{N}) for the Percentage Government Bond Price Volatility Index case and S^{bp}(t,T,T_{N}) for the Basis Point Government Bond Price Volatility Index case; and xₜ is the weight such that

$${x}_{i} \frac{{T}_{i} - t}{12 d} + ( 1 - {x}_{t} ) \frac{{T}_{i + 1} - t}{12 d} = \frac{m}{12} , t ∈ [ {T}_{i - 1} , {T}_{i} ]$$

which leads to the expression

$${I}_{t} ≡ \sqrt{\frac{1}{( m / 12 )} [ ( \frac{{T}_{i + 1} - t}{m \times d} - 1 ) {V}_{t} ( {T}_{i} ) + ( 2 - \frac{{T}_{i + 1} - t}{m \times d} ) {V}_{t} ( {T}_{i + 1} )} , \\ t ∈ [ {T}_{i - 1} , {T}_{i} ]$$

For the case of the Basis Point Yield Government Bond Volatility Index, the sandwich combination at time t may be expressed as

$${I}_{Y}^{bp} ≡ 100 \times {\hat{P}}^{- 1} [ \frac{{I}_{t}^{BP}}{{I}_{t}^{Perc}} ] \times {I}_{t}^{perc}$$

and for the case of the Modified-Duration Based Basis Point Yield Government Bond Volatility Index, the sandwich combination at time t may be expressed as

$${I}_{Yd , t}^{bp} ≡ \frac{100 \times ( 1 + {\hat{P}}_{T}^{- 1} [ \frac{{I}_{t}^{bp}}{{I}_{t}^{perc}} ] ) \times {I}_{t}^{bp}}{\begin{matrix}{\sum }_{i = j}^{N} \frac{{C}_{i}}{n} {( 1 + {\hat{P}}_{T}^{- 1} [ \frac{{I}_{t}^{bp}}{{I}_{t}^{perc}} ] )}^{- \frac{d c ( {t}_{i} - T )}{d c ( year )}} ( \frac{d c ( {t}_{i} - T )}{d c ( year )} ) + \\ 100 {( 1 + {\hat{P}}_{T}^{- 1} [ \frac{{I}_{t}^{bp}}{{I}_{t}^{perc}} ] )}^{- \frac{d c ( {t}_{N} - T )}{d c ( year )}} ( \frac{d c ( {t}_{N} - T )}{d c ( year )} )\end{matrix}}$$

where Iₜ^{BP} is the sandwich combination for the Basis Point Government Bond Price Volatility Index and Iₜ^{perc} is the sandwich combination for the Percentage Government Bond Price Volatility Index.

In the case where GB forward and forward options trade with maturity cycles, as a second non-limiting example, the volatility index may be calculated based on the skew of a particular future option contract with a shrinking time to maturity. For example, if the index is based on options expiring in three months on a ten year bond, the index on the first day would reflect expected volatility over the next three months, on the next day would reflect expected volatility over the next three months minus one day, and so on, until the index naturally expires at option expiry in three months. The same methodology may be used in the case of GB futures and future options.

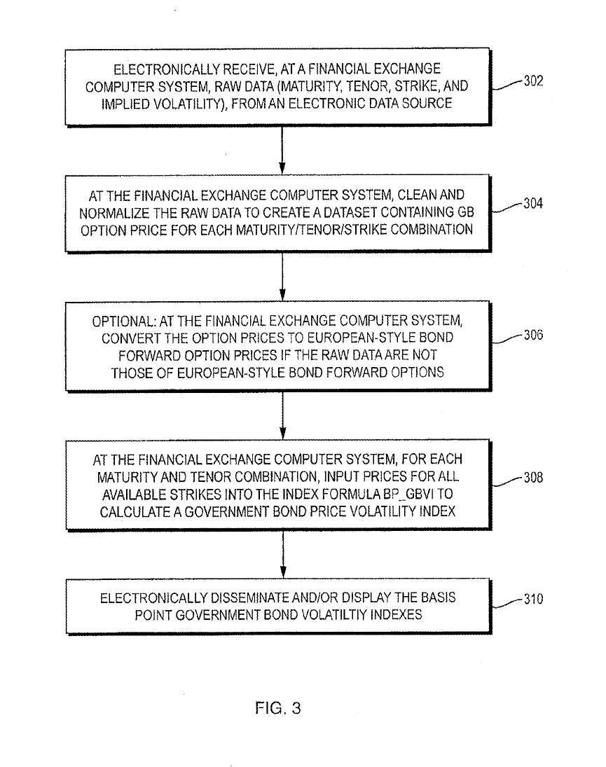

FIG. 3, is a flow diagram that outlines an embodiment of the steps for calculating and disseminating a Basis Point Government Bond Price Volatility Index according to the present invention. At step 302, data is received electronically from an electronic data source. Included in the received data is data regarding the GB options. At step 304, the data is cleaned and normalized, according to known techniques, and GB option price data are created as input for the index formula for all available maturity/tenor/strike combinations At step 306, if the option prices are not those of European-style bond future options, they may optionally be converted to corresponding prices of European-style bond future options. At step 308, the prices for each maturity and tenor combination for all available strikes are inputted into equation BP_GBVI, shown above, to calculate a basis point GB volatility index.

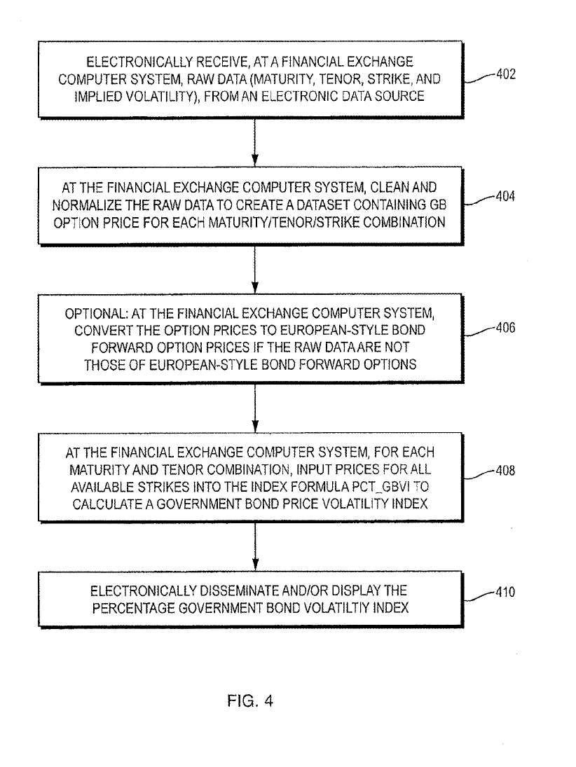

FIG. 4, is a flow diagram that outlines an embodiment of the steps for calculating and disseminating a Percentage Government Bond Price Volatility Index according to the present invention. At step 402, data is received electronically from an electronic data source. Included in the received data is data regarding the GB options. At step 404, the data is cleaned and normalized, according to known techniques, and a GB option price data created as input for the index formula for all available maturity/tenor/strike combinations. At step 406, if the option prices are not those of European-style bond future options, they may optionally be converted to corresponding prices of European-style future options. At step 408, the prices for each maturity and tenor combination for all available strikes are inputted into equation PCT_GBVI, shown above, to calculate a Percentage Government Bond Price Volatility Index.

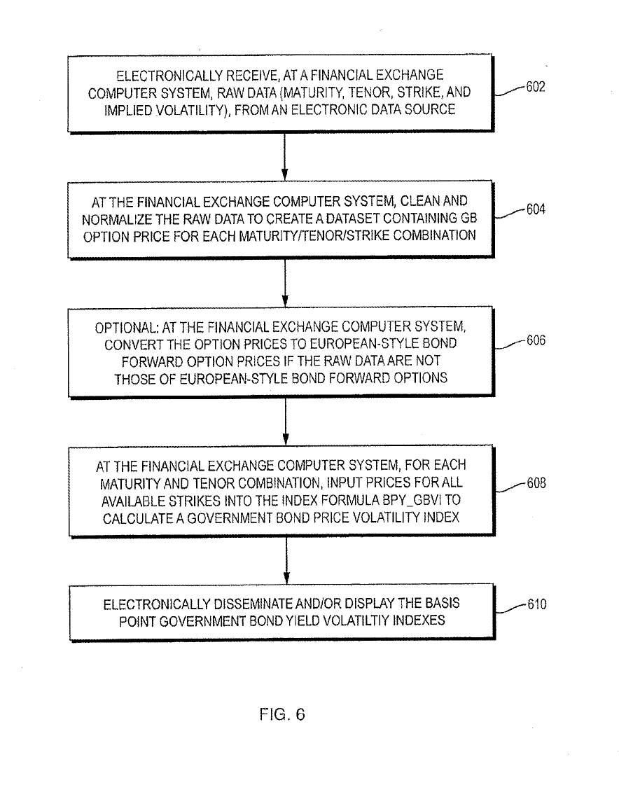

FIG. 6, is a flow diagram that outlines an embodiment of the steps for calculating and disseminating a Basis Point Government Bond Yield Volatility Index according to the present invention. At step 602, data is received electronically from an electronic data source. Included in the received data is data regarding the GB options. At step 604, the data is cleaned and normalized, according to known techniques, and a GB option price data created as input for the index formula for all available maturity/tenor/strike combinations. At step 606, if the option prices are not those of European-style bond future options, they may optionally be converted to corresponding prices of European-style future options. At step 608, the prices for each maturity and tenor combination for all available strikes are inputted into equation BPY GBVI, shown above, to calculate a Basis Point Government Bond Yield Volatility Index.

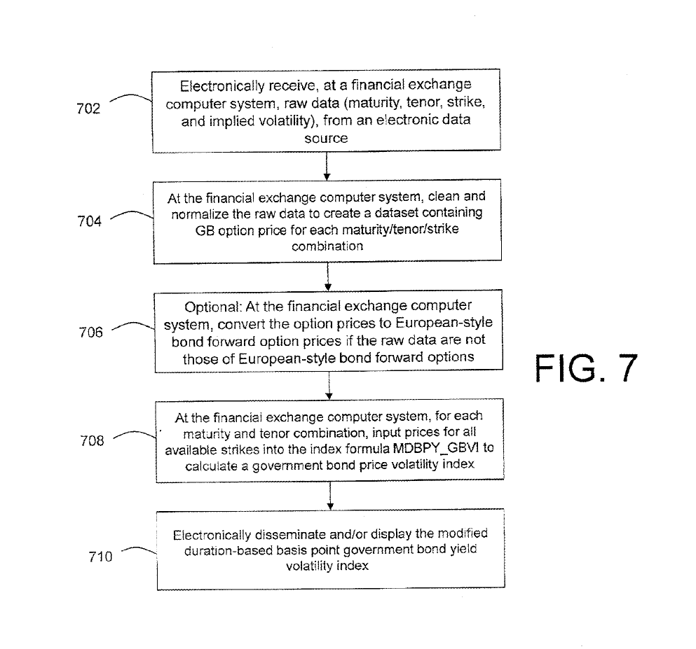

FIG. 7, is a flow diagram that outlines an embodiment of the steps for calculating and disseminating a Modified Duration-Based Basis Point Government Bond Yield Volatility Index according to the present invention. At step 702, data is received electronically from an electronic data source. Included in the received data is data regarding the GB options. At step 704, the data is cleaned and normalized, according to known techniques, and a GB option price data created as input for the index formula for all available maturity/tenor/strike combinations. At step 706, if the option prices are not those of European-style bond future options, they may optionally be converted to corresponding prices of European-style future options. At step 708, the prices for each maturity and tenor combination for all available strikes are inputted into equation MDBPY_GBVI, shown above, to calculate a Modified Duration-Based Basis Point Government Bond Yield Volatility Index.

The steps shown in FIGS. 3, 4, 6, and 7 can be performed using the systems illustrated in FIGS. 1, 2, and 5.

### Implementation Examples

The following is a non-limiting example of how the methodologies of the present invention can be used to construct the three formulations of Government Bond Volatility Indexes. As noted above the actual calculation and dissemination of the Basis Point Government Bond Price Volatility Index, Percentage Government Bond Price Volatility Index, Basis Point Government Bond Yield Volatility Index, and Modified-Duration Based Basis Point Government Bond Yield Volatility Index are performed by the calculation and dissemination system, an example of which is illustrated in FIG. 3.

The present example utilizes data reflecting hypothetical market conditions. The data provided are premiums for European-style forward put and call options, expressed in decimals, on a ten year GB forward maturing in one month. The data for this example is provided below in table 1:

TABLE 1

| | | Premiums | |
|---|---|---|---|
| Strike | Percentage | Put | Call |
| Price (%) | Implied Vol | Option | Option |
| 125.00 | 9.10 | 0.2343 · 10⁻³ | 7.0234 · 10⁻² |
| 125.50 | 8.53 | 0.2346 · 10⁻³ | 6.5234 · 10⁻² |
| 126.00 | 7.32 | 0.1326 · 10⁻³ | 6.0132 · 10⁻² |
| 126.50 | 6.78 | 0.1328 · 10⁻³ | 5.5132 · 10⁻² |
| 127.00 | 7.24 | 0.3423 · 10⁻³ | 5.0342 · 10⁻² |
| 127.50 | 6.64 | 0.3465 · 10⁻³ | 4.5346 · 10⁻² |
| 128.00 | 6.33 | 0.4516 · 10⁻³ | 4.0451 · 10⁻² |
| 128.50 | 6.15 | 0.6567 · 10⁻³ | 3.5656 · 10⁻² |
| 129.00 | 5.81 | 0.8557 · 10⁻³ | 3.0855 · 10⁻² |
| 129.50 | 5.63 | 1.2506 · 10⁻³ | 2.6250 · 10⁻² |
| 130.00 | 5.35 | 1.7225 · 10⁻³ | 2.1722 · 10⁻² |
| 130.50 | 5.05 | 2.3656 · 10⁻³ | 1.7365 · 10⁻² |
| 131.00 | 4.82 | 3.3632 · 10⁻³ | 1.3363 · 10⁻² |
| 131.50 | 4.71 | 4.9229 · 10⁻³ | 9.9229 · 10⁻³ |
| 132.00 | 4.53 | 6.8864 · 10⁻³ | 6.8864 · 10⁻³ |
| (ATM) | | | |
| 132.50 | 4.43 | 9.5398 · 10⁻³ | 4.5398 · 10⁻³ |
| 133.00 | 4.40 | 1.2865 · 10⁻² | 2.8655 · 10⁻³ |
| 133.50 | 4.38 | 1.6705 · 10⁻² | 1.7053 · 10⁻³ |
| 134.00 | 4.40 | 2.0979 · 10⁻² | 0.9793 · 10⁻³ |
| 134.50 | 4.58 | 2.5619 · 10⁻² | 0.6192 · 10⁻³ |
| 135.00 | 4.78 | 3.0400 · 10⁻² | 0.4000 · 10⁻³ |
| 135.50 | 4.93 | 3.5246 · 10⁻² | 0.2462 · 10⁻³ |
| 136.00 | 5.17 | 4.0169 · 10⁻² | 0.1696 · 10⁻³ |
| 136.50 | 5.21 | 4.5090 · 10⁻² | 9.0837 · 10⁻⁵ |

The first two columns of Table 1, as shown above, report strike price, K, and percentage implied volatilities for each strike price, IV(K). The third and fourth columns provide call and put option premiums.

Table 2, as shown below, provides information regarding the present examples calculation of the Basis Point Government Bond Price Volatiltiy Index and, Percentage Government Bond Price Volatility Index, according to equations (BP_GBVI) and (PCT_GBVI) respectively.

TABLE 2

| | | | Weights | | Contributions to Strikes | |
|---|---|---|---|---|---|---|
| Strike | Option | | Basis Point | Percentage | Basis Point | Percentage |
| Price (%) | Type | Price | ΔKᵢ | ΔKᵢ/Kᵢ² | Contribution | Contribution |
| 125.00 | Put | 0.2343 · 10⁻³ | 0.005 | 3.2000 · 10⁻³ | 1.1715 · 10⁻⁶ | 7.4976 · 10⁻⁷ |
| 125.50 | Put | 0.2346 · 10⁻³ | 0.005 | 3.1745 · 10⁻³ | 1.1733 · 10⁻⁶ | 7.4494 · 10⁻⁷ |
| 126.00 | Put | 0.1326 · 10⁻³ | 0.005 | 3.1494 · 10⁻³ | 6.6302 · 10⁻⁷ | 4.1762 · 10⁻⁷ |
| 126.50 | Put | 0.1328 · 10⁻³ | 0.005 | 3.1245 · 10⁻³ | 6.6429 · 10⁻⁷ | 4.1512 · 10⁻⁷ |
| 127.00 | Put | 0.3423 · 10⁻³ | 0.005 | 3.1000 · 10⁻³ | 1.7118 · 10⁻⁶ | 1.0613 · 10⁻⁶ |
| 127.50 | Put | 0.3165 · 10⁻³ | 0.005 | 3.0757 · 10⁻³ | 1.7326 · 10⁻⁰ | 1.0658 · 10⁻⁶ |
| 128.00 | Put | 0.4516 · 10⁻³ | 0.005 | 3.0517 · 10⁻³ | 2.2580 · 10⁻⁶ | 1.3781 · 10⁻⁶ |
| 128.50 | Put | 0.6367 · 10⁻³ | 0.005 | 3.0280 · 10⁻³ | 3.2838 · 10⁻⁶ | 1.9887 · 10⁻⁶ |
| 129.00 | Put | 0.8557 · 10⁻³ | 0.005 | 3.0046 · 10⁻³ | 4.2785 · 10⁻⁶ | 2.5710 · 10⁻⁶ |
| 129.50 | Put | 1.2506 · 10⁻³ | 0.005 | 2.9914 · 10⁻³ | 6.2534 · 10⁻⁶ | 3.7289 · 10⁻⁶ |
| 130.00 | Put | 1.7225 · 10⁻³ | 0.005 | 2.9585 · 10⁻³ | 8.6128 · 10⁻⁶ | 5.0963 · 10⁻⁶ |
| 130.50 | Put | 2.3656 · 10⁻³ | 0.005 | 2.9359 · 10⁻³ | 1.1828 · 10⁻⁵ | 6.9454 · 10⁻⁶ |
| 131.00 | Put | 3.3632 · 10⁻³ | 0.005 | 2.9135 · 10⁻³ | 1.6816 · 10⁻⁵ | 9.7990 · 10⁻⁶ |
| 131.50 | Put | 4.9229 · 10⁻³ | 0.005 | 2.8914 · 10⁻³ | 2.4814 · 10⁻⁵ | 1.4234 · 10⁻⁵ |
| 132.00 | ATM | 6.8864 · 10⁻³ | 0.005 | 2.8596 · 10⁻³ | 3.4431 · 10⁻⁵ | 1.9761 · 10⁻⁵ |
| 132.50 | Call | 4.5395 · 10⁻³ | 0.005 | 2.8479 · 10⁻³ | 2.2699 · 10⁻⁵ | 1.2925 · 10⁻⁵ |
| 133.00 | Call | 2.8655 · 10⁻³ | 0.005 | 2.8266 · 10⁻³ | 1.4327 · 10⁻⁵ | 8.0999 · 10⁻⁶ |
| 133.50 | Call | 1.7053 · 10⁻³ | 0.005 | 2.8054 · 10⁻³ | 8.5265 · 10⁻⁶ | 4.7842 · 10⁻⁶ |
| 134.00 | Call | 0.9793 · 10⁻³ | 0.005 | 2.7845 · 10⁻³ | 4.8959 · 10⁻⁶ | 2.7271 · 10⁻⁶ |
| 134.50 | Call | 0.6192 · 10⁻³ | 0.005 | 2.7632 · 10⁻³ | 3.0963 · 10⁻⁶ | 1.7118 · 10⁻⁶ |
| 135.00 | Call | 0.4000 · 10⁻³ | 0.005 | 2.7434 · 10⁻³ | 2.0502 · 10⁻⁶ | 1.0975 · 10⁻⁶ |
| 135.50 | Call | 0.2462 · 10⁻³ | 0.005 | 2.7232 · 10⁻³ | 1.2312 · 10⁻⁶ | 8.7062 · 10⁻⁷ |
| 136.00 | Call | 0.1696 · 10⁻³ | 0.005 | 2.7032 · 10⁻³ | 8.4830 · 10⁻⁷ | 4.5864 · 10⁻⁷ |
| 136.50 | Call | 9.0837 · 10⁻⁵ | 0.005 | 2.6835 · 10⁻³ | 4.5418 · 10⁻⁷ | 2.4376 · 10⁻⁷ |
| | | | | SUMS | 1.7757 · 10⁻⁴ | 1.0268 · 10⁻⁴ |

The second column of Table 2 displays the type of at-the-money and out-of the money GB forward option entering in the calculations of the embodiments of the GB Volatility Indexes. The third column displays option premiums entering into the calculation; the fourth and fifth columns report the weights each option premium bears towards the final computation of the index; and finally, the sixth and seventh columns report each out-of-the money option premium multiplied by the appropriate weight. Each price in the third column is multiplied by the corresponding weight in the fourth column, for the “Basis Point Contribution,” and each price in the third column is multiplied by the corresponding weight in the fifth column, for the “Percentage Contribution.”

Thus, according to the data provided in this example, embodiments of the Basis Point Government Bond Price Volatiltiy Index and Percentage Government Bond Price Volatiltiy Index are calculated, respectively, as follows:

$$GB - {VI}^{BP} = {100}^{2} \times \sqrt{\frac{1}{0.9980} \frac{2}{( 1 / 12 )} \times 1.7757 \cdot {10}^{- 4}} = 653.4751$$

$$and$$

$$GB - VI = 100 \times \sqrt{\frac{1}{0.9980} \frac{2}{( 1 / 12 )} \times 1.0268 \cdot {10}^{- 4}} = 4.9692 .$$

The rescaling factor inside the square roots, (1/0.9980), is the inverse of a zero coupon bond expiring in one month.

The Basis Point Yield Government Bond Volatility Index value may then be calculated by first solving for

$${B}_{*} = \frac{GB - {VI}^{bp}}{GB - VI} = \frac{653.4751}{4.9692} = 131.5121$$

then obtaining the implied yield of y_{B}=\hat{P}⁻¹(131.5121)=7.2226×10⁻³ assuming n=1, N=10, and Cᵢ=4, which leads to

GB-VI_{I}^{bp}=100×7.2226×10⁻³×4.9692=3.5891

and

GB-VI_{Yd}^{bp}=100×4.9692/8.6048=57.749

For purposes of comparison, the at-the-money implied basis point and percentage volatilities are IV^{BP}(ATM)=597.96 and IV(ATM)=4.53%.

In this non-limiting example, the basis point index is rescaled by 100², to mimic the market practice to express basis point implied volatility as the product of rates times log-volatility, where both rates and log-volatility are multiplied by 100.

According to some embodiments of the present invention, indices calculated according to the embodiments of the present invention may serve as the underlying value for derivative contracts, such as options and futures contracts. More particularly, according to an embodiment of the present invention, a Government Bond Volatility Index (GB-VI) may serve as the underlying reference for derivative contracts designed for trading the volatility of GB futures prices of various maturities and underlying tenors. In particular, futures and options contracts with varying maturities based on the index may be traded OTC and/or listed on exchanges.

Derivative instruments based on the government bond volatility index disclosed above may be created as standardized, exchange-traded contracts, as well as over-the-counter contracts. Once the government bond volatility index (GB-VI) based on government future/forward options is calculated, the index may be accessed for use in creating a derivative contract, and the derivative contract may be assigned a unique symbol. Generally, the GB-VI derivative contract may be assigned any unique symbol that serves as a standard identifier for the type of standardized GB-VI derivative contract. Information associated with the GB-VI and/or the GB-VI derivative contract may be transmitted for display, such as transmitting information to list the GB-VI index and/or the GB-VI derivative on a trading platform. Examples of the types of information that may be transmitted for display include a settlement price of a GB-VI derivative, a bid or offer associated with a GB-VI derivative, a value of a GB-VI index, and/or a value of an underlying option that a GB-VI is associated with.

Generally, a GB-VI derivative contract may be listed on an electronic platform, an open outcry platform, a hybrid environment that combines the electronic platform and open outcry platform, or any other type of platform known in the art. One example of a hybrid exchange environment is disclosed in U.S. Pat. No. 7,613,650, filed Apr. 24, 2003, the entirety of which is herein incorporated by reference. Additionally, a trading platform such as an exchange may transmit GB-VI derivative contract quotes of liquidity providers over dissemination networks to other market participants. Liquidity providers may include Designated Primary Market Makers (“DPM”), market makers, locals, specialists, trading privilege holders, registered traders, members, or any other entity that may provide a trading platform with a quote for a variance derivative. Dissemination Networks may include networks such as the Options Price Reporting Authority (“OPRA”), the CBOE Futures Network, an Internet website or email alerts via email communication networks. Market participants may include liquidity providers, brokerage firms, normal investors, or any other entity that subscribes to a dissemination network.

The trading platform may execute buy and sell orders for the GB-VI derivative and may repeat the steps of calculating the GB-VI of the underlying options, accessing the GB-VI index, transmitting information for the GB-VI index and/or the GB-VI derivative for display (list the GB-VI and/or GB-VI derivative on a trading platform), disseminating the GB-VI and/or the GB-VI derivative over a dissemination network, and executing buy and sell orders for the GB-VI derivative until the GB-VI derivative contract is settled.

In some implementations, GB-VI derivative contracts may be traded through an exchange-operated parimutuel auction and cash-settled based on the GB-VI index of log returns of the underlying equity. An electronic parimutuel, or Dutch, auction system conducts periodic auctions, with all contracts that settle in-the-money funded by the premiums collected for those that settle out-of-the-money.

As mentioned, in a parimutuel auction, all the contracts that settle in-the-money are funded by those that settle out-of-the-money. Thus, the net exposure of the system is zero once the auction process is completed, and there is no accumulation of open interest over time. Additionally, the pricing of contracts in a parimutuel auction depends on relative demand; the more popular the strike, the greater its value. In other words, a parimutuel auction does not depend on market makers to set a price; instead the price is continuously adjusted to reflect the stream of orders coming into the auction. Typically, as each order enters the system, it affects not only the price of the sought-after strike, but also affects all the other strikes available in that auction. In such a scenario, as the price rises for the more sought-after strikes, the system adjusts the prices downward for the less popular strikes. Further, the process does not require the matching of specific buy orders against specific sell orders, as in many traditional markets. Instead, all buy and sell orders enter a single pool of liquidity, and each order can provide liquidity for other orders at different strike prices and the liquidity is maintained such that system exposure remains zero. This format maximizes liquidity, a key feature when there is no tradable underlying instrument.

The following characteristics of futures contracts illustrate one embodiment of a futures contract having an index of the present invention as an underlying asset. The characteristics are not meant to limit the present invention, but rather to set forth common characteristics of futures.

Contract Size: The notional amount of one unit of the contract may be defined as a multiple of the index level, which may depend on the currency of the underlying index. When traded OTC, the multiplier may be negotiated between the parties involved on a trade-by-trade basis.

Contract Months: An exchange may list contracts with a pre-determined sequence of maturity dates, e.g. the 3rd Friday of each of the next 6 months. Similarly, OTC dealers may make markets in a pre-determined sequence of maturity dates but may also make markets for contracts that mature on other dates on a trade-by-trade basis.

Quotation & Minimum Price Intervals: Futures based on the index may be quoted in points and decimals or fractions that represent some notional amount per contract and there may be a minimum increment by which the pricing of the contracts may vary, both of which may depend on the currency of the underlying index. The OTC market may adopt different conventions for quoting and minimum ticks.

Last Trading Date: For each contract, a last trading date will be specified.

Final Settlement Date: For each contract, a final settlement date will be specified.

Final Settlement Value: The final settlement value shall be based on the level of the index computed at a pre-specified time on the settlement date.

Delivery: Settlement of futures based on the index will take the form of a delivery of the cash settlement amount and a payment date will be specified in relation to the final settlement date.

Additional Specifications when Exchange Traded: When traded on an exchange, trading platform, margin requirements, trading hours, order crossing rules, block trading rules, reporting rules, and other details may be specified.

The following characteristics of options contracts illustrate one embodiment of an options contract having an index of the present invention as an underlying asset. The characteristics are not meant to limit the present invention, but rather to set forth common characteristics of options.

Contract Size: The notional amount of one unit of the contract may be defined as a multiple of the index level, which may depend on the currency of the underlying index. When traded OTC, the multiplier may be negotiated between the parties involved on a trade-by-trade basis.

Contract Months: An exchange may list contracts with a pre-determined sequence of expiration dates, e.g. the 3rd Friday of each of the next 6 months. Similarly, OTC dealers may make markets in a pre-determined sequence of maturity dates but may also make markets for contracts that expire on other dates on a trade-by-trade basis.

Strike Prices: For each currency, strike prices that are in-, at-, and out-of the money may be listed by an exchange or quoted by OTC dealers and new strike prices may be traded as future prices increase and decrease. An exchange or the OTC dealer community may fix a minimum increment between strike prices, depending on the currency of the underlying index.

Quotation & Minimum Price Intervals: Options based on the index may be quoted in points and decimals or fractions that represent some notional amount per contract and there may be a minimum increment by which the pricing of the contracts may vary, both of which may depend on the currency of the underlying index. The OTC Market may adopt different conventions for quoting and minimum ticks.

Exercise Style: Options written on the GB-VI are likely to be, but not limited to, European style. It is envisioned that American style contracts could also have an index of the present invention as an underlying asset

Expiration Date: For each contract, an expiration date will be specified.

Last Trading Date: For each contract, a last trading date will be specified.

Settlement of Exercise: The final settlement value shall be based on the level of the index computed at a pre-specified time on the settlement date. The cash settlement amount will be the difference between the index level and the strike price, possibly adjusted by some multiplier, and a payment date will be specified in relation to the expiration date.

Additional Specifications when Exchange Traded: When traded on an exchange, trading platform, margin requirements, trading hours, reporting rules, and other details may be specified.

According to other embodiments of the present invention, other financial products that track or reference the indices of the present invention may be created. Such products include, but are not limited to, Exchange Traded Funds and Exchange Traded Notes listed on exchanges and structured products sold by financial institutions.

The foregoing description has been directed to specific embodiments of this invention. It will be apparent, however, that other variations and modifications may be made to the described embodiments, with the attainment of some or all of their advantages

What is claimed is:

1. A computer system for calculating a government bond volatility index comprising:
memory configured to store at least one program; and
at least one processor communicatively coupled to the memory, in which the at least one program, when executed by the at least one processor, causes the at least one processor to:
receive data regarding options on government bond derivatives;
calculate, using the data regarding options on government bond derivatives, the government bond volatility index; and
transmit data regarding the government bond volatility index.

2. The computer system of claim 1, wherein the data regarding options on government bond derivatives includes data regarding prices of options on government bond derivatives.

3. The computer system of claim 2, wherein the data regarding prices of options on government bond derivatives includes data regarding prices of options on government bond futures or government bond forwards.

4. The computer system of claim 3, wherein the government bond volatility index is calculated at time t according to the equation:
$$GB - VI ( t , T , {T}_{D} , {T}_{N} ) ≡ 100 \times \sqrt{\frac{1}{( T - t )} [ \begin{matrix}\frac{2}{{P}_{t} ( T )} [ \begin{matrix}{\sum }_{i : {K}_{i} < {K}_{*}} \frac{{Put}_{t} ( {K}_{i} , T , {T}_{D} , {T}_{N} )}{{K}_{i}^{2}} Δ {K}_{i} + \\ {\sum }_{i : {K}_{i} \geq {K}_{*}} \frac{{Call}_{t} ( {K}_{i} , T , {T}_{D} , {T}_{N} )}{{K}_{i}^{2}} Δ {K}_{i}\end{matrix} ] - \\ {( \frac{{F}_{t} ( {T}_{D} , {T}_{N} ) - {K}_{*}}{{K}_{*} } )}^{2}\end{matrix} ]}$$
wherein:
t denotes a time at which the government bond volatility index is calculated;
T denotes a time of expiry of options on government bond derivatives;
T_{D} denotes a time of maturity of government bond derivatives underlying the options where T_{D}≥T;
T_{N} denotes a time of expiry of government bonds;
Z+1 denotes a total number of options used in the index calculation;
K₀ denotes the lowest strike of the Z+1 options;
Kᵢ denotes the i^{th} highest strike of the Z+1 options;
K_{Z} denotes the highest strike of the Z+1 options;
ΔKᵢ=1/2(Kᵢ₊₁−Kᵢ₋₁) for i≥1, and ΔK₀=(K₁−K₀), ΔK_{Z}=(K_{Z}−K_{Z-1});
if the price is observable at time t, then Fₜ(T_{D},T_{N}) is a price at time t of a government bond derivative contract underlying the put and call options, expiring at T_{D} with an underlying government bond maturing at T_{N};
if the price is not observable at time t, then Fₜ(T_{D},T_{N}) is the strike at which the difference between the put and call prices is smallest;
if there exists an option struck at Fₜ(T_{D},T_{N}), then K* equals Fₜ(T_{D},T_{N});
if there does not exist an option struck at Fₜ(T_{D},T_{N}), then K* is the first available strike below Fₜ(T_{D},T_{N});
Pₜ(T) is a price at time t of a zero-coupon non-defaultable bond maturing at T;
Putₜ(KᵢT,T_{D},T_{N}) is a price at time t of a put option, struck at Kᵢ, expiring at T, and having an underlying government bond derivative expiring at T_{D} with an underlying bond maturing at T_{N};
Callₜ(Kᵢ,T,T_{D},T_{N}) is a price at time t of a call option, struck at Kᵢ, expiring at T, and having an underlying government bond derivative expiring at T_{D} with an underlying bond maturing at T_{N}; and
GB-VI(t,T,T_{D},T_{N}) is the value of the government bond volatility index at time t calculated based on options expiring at T on government bond derivatives expiring at T_{D} with an underlying bond maturing at T_{N}.

5. The computer system of claim 3, wherein the government bond volatility index is calculated at time t according to the equation:
$$GB - {VI}^{bp} ( t , T , {T}_{D} , {T}_{N} ) ≡ {100}^{2} \times \sqrt{\frac{1}{( T - t )} [ \begin{matrix}\frac{2}{{P}_{t} ( T )} [ \begin{matrix}{\sum }_{i : {K}_{i} < {K}_{*}} {Put}_{t} ( {K}_{i} , T , {T}_{D} , {T}_{N} ) Δ {K}_{i} + \\ {\sum }_{i : {K}_{i} \geq {K}_{*}} {Call}_{t} ( {K}_{i} , T , {T}_{D} , {T}_{N} ) Δ {K}_{i}\end{matrix} ] - \\ {( {F}_{t} ( {T}_{D} , {T}_{N} ) - {K}_{*} )}^{2}\end{matrix} ]}$$
wherein:
t denotes a time at which the government bond volatility index is calculated;
T denotes a time of expiry of options on government bond derivatives;
T_{D} denotes a time of maturity of government bond derivatives underlying the options where T_{D}≥T;
T_{N} denotes a time of expiry of government bonds;
Z+1 denotes a total number of options used in the index calculation;
K₀ denotes the lowest strike of the Z+1 options;
Kᵢ denotes the i^{th} highest strike of the Z+1 options;
K_{Z} denotes the highest strike of the Z+1 options;
ΔKᵢ=1/2(Kᵢ₊₁−Kᵢ₋₁) for i≥1, and ΔK₀=(K₁−K₀), ΔK_{Z}=(K_{Z}−K_{Z-1});
if the price is observable at time t, then Fₜ(T_{D},T_{N}) is a price at time t of a government bond derivative contract underlying the put and call options, expiring at T_{D} with an underlying government bond maturing at T_{N};
if the price is not observable at time t, then Fₜ(T_{D},T_{N}) is the strike at which the difference between the put and call prices is smallest;
if there exists an option struck at Fₜ(T_{D},T_{N}), then K* equals Fₜ(T_{D},T_{N});
if there does not exist an option struck at Fₜ(T_{D},T_{N}), then K* is the first available strike below Fₜ(T_{D},T_{N});
Pₜ(T) is a price at time t of a zero-coupon non-defaultable bond maturing at T;
Putₜ(KᵢT,T_{D},T_{N}) is a price at time t of a put option, struck at Kᵢ, expiring at T, and having an underlying government bond derivative expiring at T_{D} with an underlying bond maturing at T_{N};
Callₜ(Kᵢ,T,T_{D},T_{N}) is a price at time t of a call option, struck at Kᵢ, expiring at T, and having an underlying government bond derivative expiring at T_{D} with an underlying bond maturing at T_{N}; and
GB-VI^{bp}(t,T,T,T_{N}) is the value of the government bond volatility index at time t calculated based on options expiring at T on government bond derivatives expiring at T_{D} with an underlying bond maturing at T_{N}.

6. The computer system of claim 3,
wherein, in the absence of accrued coupons at time T, the government bond volatility index is calculated at time t according to the equation:
$$GB - VI ( t , T , {T}_{D} , {T}_{N} ) ≡ 100 \times {\hat{P}}^{- 1} [ \frac{GB - {VI}^{bp} ( t , T , {T}_{D} , {T}_{N} )}{GB - VI ( t , T , {T}_{D} , {T}_{N} )} ] \times GB - VI ( t , T , {T}_{D} , {T}_{N} )$$
$$where$$
$$\hat{P} ( y ) ≡ {\sum }_{i = 1}^{N} \frac{{C}_{i}}{n} {( 1 + \frac{y}{n} )}^{- i} + 100 {( 1 + \frac{y}{n} )}^{- N} ;$$
and, wherein, in the presence of accrued coupons at time T with the next coupon due at tⱼ, the government bond volatility index is calculated at time t according to the equation:
$$GB - {VI}_{Y}^{bp} ( t , T , {T}_{D} , {T}_{N} ) ≡ 100 \times {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] \times GB - VI ( t , T , {T}_{D} , {T}_{N} )$$
$$where$$
$${\hat{P}}_{T} ( x ) ≡ {\sum }_{i = j}^{N} \frac{{C}_{i}}{n} {( 1 + x )}^{- \frac{d c ( {t}_{i} - T )}{d c ( year )}} + 100 {( 1 + x )}^{- \frac{d c ( {t}_{N} - T )}{d c ( year )}}$$
$$and$$
$$GB - VI ( t , T , {T}_{D} , {T}_{N} ) ≡ 100 \times \sqrt{\frac{1}{( T - t )} [ \begin{matrix}\frac{2}{{P}_{t} ( T )} [ \begin{matrix}{\sum }_{i : {K}_{i} < {K}_{*}} \frac{{Put}_{t} ( {K}_{i} , T , {T}_{D} , {T}_{N} )}{{K}_{i}^{2}} Δ {K}_{i} + \\ {\sum }_{i : {K}_{i} \geq {K}_{*}} \frac{{Call}_{t} ( {K}_{i} , T , {T}_{D} , {T}_{N} )}{{K}_{i}^{2}} Δ {K}_{i}\end{matrix} ] - \\ {( \frac{{F}_{t} ( {T}_{D} , {T}_{N} ) - {K}_{*}}{{K}_{*}} )}^{2}\end{matrix} ]}$$
$$and$$
$$GB - {VI}^{bp} ( t , T , {T}_{D} , {T}_{N} ) ≡ {100}^{2} \times \sqrt{\frac{1}{( T - t )} [ \begin{matrix}\frac{2}{{P}_{t} ( T )} [ \begin{matrix}{\sum }_{i : {K}_{i} < {K}_{*}} {Put}_{t} ( {K}_{i} , T , {T}_{D} , {T}_{N} ) Δ {K}_{i} + \\ {\sum }_{i : {K}_{i} \geq {K}_{*}} {Call}_{t} ( {K}_{i} , T , {T}_{D} , {T}_{N} ) Δ {K}_{i}\end{matrix} ] - \\ {( {F}_{t} ( {T}_{D} , {T}_{N} ) - {K}_{*} )}^{2}\end{matrix} ]}$$
wherein:
t denotes a time at which the government bond volatility index is calculated;
T denotes a time of expiry of options on government bond derivatives;
tⱼ is the first coupon payment on or after T;
T_{D} denotes a time of maturity of government bond derivatives underlying the options where T_{D}≥T;
T_{N} denotes a time of expiry of government bonds;
Z+1 denotes a total number of options used in the index calculation;
K₀ denotes the lowest strike of the Z+1 options;
Kᵢ denotes the i^{th} highest strike of the Z+1 options;
K_{Z} denotes the highest strike of the Z+1 options;
ΔKᵢ=1/2(Kᵢ₊₁−Kᵢ₋₁) for i≥1, and ΔK₀=(K₁−K₀), ΔK_{Z}=(K_{Z}=K_{Z-1});
if the price is observable at time t, then Fₜ(T_{D},T_{N}) is a price at time t of a government bond derivative contract underlying the put and call options, expiring at T_{D} with an underlying government bond maturing at T_{N};
if the price is not observable at time t, then Fₜ(T_{D},T_{N}) is the strike at which the difference between the put and call prices is smallest;
if there exists an option struck at Fₜ(T_{D},T_{N}), then K* equals Fₜ(T_{D},T_{N});
if there does not exist an option struck at Fₜ(T_{D},T_{N}), then K* is the first available strike below Fₜ(T_{D},T_{N});
Pₜ(T) is a price at time t of a zero-coupon non-defaultable bond maturing at T;
Putₜ(Kᵢ,T,T_{D},T_{N}) is a price at time t of a put option, struck at Kᵢ, expiring at T, and having an underlying government bond derivative expiring at T_{D} with an underlying bond maturing at T_{N};
Callₜ(Kᵢ,T,T_{D},T_{N}) is a price at time t of a call option, struck at Kᵢ, expiring at T, and having an underlying government bond derivative expiring at T_{D} with an underlying bond maturing at T_{N};
N denotes the total number of coupon payments of a government bond;
Cᵢ denotes the amount of the i^{th} coupon out of N coupons of a government bond;
n denotes the frequency of coupon payments per annum of a government bond;
y denotes the yield of a government bond;
x denotes the yield of a government bond;
\hat{P}(y) is a bond price corresponding to a bond yield of a coupon-bearing government bond;
\hat{P}(y) is the functional inverse of \hat{P}(y);
\hat{P}_{T}(x) is a bond price at time T corresponding to a bond yield of a coupon-bearing government bond;
\hat{P}_{T}⁻¹(x) is the functional inverse of \hat{P}_{T}(x);
dc(year) is the number of days in a year based on a day count convention used for the government bond;
dc(T-t) is the number of days between t and T based on a day count convention used for the government bond;
GB-VI_{Y}^{bp}(t,T,T_{D},T_{N}) is the value of the government bond volatility index in terms of basis point yield volatility at time t calculated based on options expiring at T on government bond derivatives expiring at T_{D} with an underlying bond maturing at T_{N};
GB-VI^{bp}(t,T,T_{D},T_{N}) is the value of the government bond volatility index in terms of basis point price volatility at time t calculated based on options expiring at T on government bond derivatives expiring at T_{D} with an underlying bond maturing at T_{N}; and
GB-VI(t,T, T_{D},T_{N}) is the value of the government bond volatility index in terms of percentage price volatility at time t calculated based on options expiring at T on government bond derivatives expiring at T_{D} with an underlying bond maturing at T_{N}.

7. The computer system of claim 3, wherein the government bond volatility index is calculated at time t according to the equation:
$$GB - {VI}_{Yd}^{bp} ( t , T , {T}_{D} , {T}_{N} ) ≡ \frac{\begin{matrix}100 \times ( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] ) \times GB - \\ {VI}^{bp} ( t , T , {T}_{D} , {T}_{N} )\end{matrix}}{\begin{matrix}{\sum }_{i = j}^{N} \frac{{C}_{i}}{n} {( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] )}^{- \frac{d c ( {t}_{i} - T )}{d c ( year )}} ( \frac{d c ( {t}_{i} - T )}{d c ( year )} ) + \\ 100 {( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] )}^{- \frac{d c ( {t}_{N} - T )}{d c ( year )}} ( \frac{d c ( {t}_{N} - T )}{d c ( year )} )\end{matrix}}$$
$$where$$
$${\hat{P}}_{T} ( x ) ≡ {\sum }_{i = j}^{N} \frac{{C}_{i}}{n} {( 1 + x )}^{- \frac{d c ( {t}_{i} - T )}{d c ( year )}} + 100 {( 1 + x )}^{- \frac{d c ( {t}_{N} - T )}{d c ( year )}}$$
$$and$$
$$GB - VI ( t , T , {T}_{D} , {T}_{N} ) ≡ 100 \times \sqrt{\frac{1}{( T - t )} [ \begin{matrix}\frac{2}{{P}_{t} ( T )} [ \begin{matrix}{\sum }_{i : {K}_{i} < {K}_{*}} \frac{{Put}_{t} ( {K}_{i} , T , {T}_{D} , {T}_{N} )}{{K}_{i}^{2}} Δ {K}_{i} + \\ {\sum }_{i : {K}_{i} \geq {K}_{*}} \frac{{Call}_{t} ( {K}_{i} , T , {T}_{D} , {T}_{N} )}{{K}_{i}^{2}} Δ {K}_{i}\end{matrix} ] - \\ {( \frac{{F}_{t} ( {T}_{D} , {T}_{N} ) - {K}_{*}}{{K}_{*}} )}^{2}\end{matrix} ]}$$
$$and$$
$$GB - {VI}^{bp} ( t , T , {T}_{D} , {T}_{N} ) ≡ {100}^{2} \times \sqrt{\frac{1}{( T - t )} [ \begin{matrix}\frac{2}{{P}_{t} ( T )} [ \begin{matrix}{\sum }_{i : {K}_{i} < {K}_{*}} {Put}_{t} ( {K}_{i} , T , {T}_{D} , {T}_{N} ) Δ {K}_{i} + \\ {\sum }_{i : {K}_{i} \geq {K}_{*}} {Call}_{t} ( {K}_{i} , T , {T}_{D} , {T}_{N} ) Δ {K}_{i}\end{matrix} ] - \\ {( {F}_{t} ( {T}_{D} , {T}_{N} ) - {K}_{*} )}^{2}\end{matrix} ]}$$
wherein:
t denotes a time at which the government bond volatility index is calculated;
T denotes a time of expiry of options on government bond derivatives;
T_{D} denotes a time of maturity of government bond derivatives underlying the options where T_{D}≥T;
T_{N} denotes a time of expiry of government bonds;
Z+1 denotes a total number of options used in the index calculation;
K₀ denotes the lowest strike of the Z+1 options;
Kᵢ denotes the i^{th} highest strike of the Z+1 options;
K_{Z} denotes the highest strike of the Z+1 options;
ΔKᵢ=1/2(Kᵢ₊₁−Kᵢ₋₁) for i≥1, and ΔK₀=(K₁−K₀), ΔK_{Z}=(K_{Z}−K_{Z-1});
if the price is observable at time t, then Fₜ(T_{D},T_{N}) is a price at time t of a government bond derivative contract underlying the put and call options, expiring at T_{D} with an underlying government bond maturing at T_{N};
if the price is not observable at time t, then Fₜ(T_{D},T_{N}) is the strike at which the difference between the put and call prices is smallest;
if there exists an option struck at Fₜ(T_{D},T_{N}), then K* equals Fₜ(T_{D},T_{N});
if there does not exist an option struck at Fₜ(T_{D},T_{N}), then K* is the first available strike below Fₜ(T_{D},T_{N});
Pₜ(T) is a price at time t of a zero-coupon non-defaultable bond maturing at T;
Putₜ(Kᵢ,T,T_{D},T_{N}) is a price at time t of a put option, struck at Kᵢ, expiring at T, and having an underlying government bond derivative expiring at T_{D} with an underlying bond maturing at T_{N};
Callₜ(Kᵢ,T,T_{D},T_{N}) is a price at time t of a call option, struck at Kᵢ, expiring at T, and having an underlying government bond derivative expiring at T_{D} with an underlying bond maturing at T_{N};
N denotes the total number of coupon payments of a government bond;
Cᵢ denotes the amount of the i^{th} coupon out of N coupons of a government bond;
n denotes the frequency of coupon payments per annum of a government bond;
x denotes the yield of a government bond;
\hat{P}_{T} (x) is a bond price corresponding to a bond yield of a coupon-bearing government bond;
\hat{P}_{T}⁻¹(x) is the functional inverse of \hat{P}_{T}(x);
dc(year) is the number of days in a year based on a day count convention used for the government bond;
dc(T-t) is the number of days between t and T based on a day count convention used for the government bond;
tⱼ is the first coupon payment on or after T;
GB-VI_{Yd}^{bp}(t,T,T_{D},T_{N}) is the value of the government bond volatility index in terms of basis point yield volatility at time t calculated based on options expiring at T on government bond derivatives expiring at T_{D} with an underlying bond maturing at T_{N};
GB-VI^{bp}(t,T,T_{D},T_{N}) is the value of the government bond volatility index in terms of basis point price volatility at time t calculated based on options expiring at T on government bond derivatives expiring at T_{D} with an underlying bond maturing at T_{N}; and
GB-VI(t,T,T_{D},T_{N}) is the value of the government bond volatility index in terms of percentage price volatility at time t calculated based on options expiring at T on government bond derivatives expiring at T_{D} with an underlying bond maturing at T_{N}.

8. The computer system of claim 1, wherein the at least one processor is further caused to:
create a standardized exchange-traded derivative instrument based on the government bond volatility index; and
transmit data regarding the standardized exchange-traded derivative.

9. The computer system of claim 8, wherein transmitting data regarding the standardized exchange-traded derivative instrument includes transmitting data regarding one or more of a settlement price, a bid price, an offer price, or a trade price of the standardized exchange-traded derivative instrument.

10. A non-transitory computer readable storage medium having computer-executable instructions recorded thereon that, when executed on a computer, configure the computer to perform a method to calculate a government bond volatility index, the method comprising:
receiving data regarding options on government bond derivatives;
calculating, using the data regarding options on government bond derivatives, the government bond volatility index; and
transmitting data regarding the government bond volatility index.

11. The non-transitory computer readable storage medium of claim 10, wherein the data regarding options on government bond derivatives includes data regarding prices of options on government bond derivatives.

12. The non-transitory computer readable storage medium of claim 11, wherein the data regarding prices of options on government bond derivatives includes data regarding prices of options on government bond futures or government bond forwards.

13. The non-transitory computer readable storage medium of claim 12, wherein the government bond volatility index is calculated at time t according to the equation:
$$GB - VI ( t , T , {T}_{D} , {T}_{N} ) ≡ 100 \times \sqrt{\frac{1}{( T - t )} [ \begin{matrix}\frac{2}{{P}_{t} ( T )} [ \begin{matrix}{\sum }_{i : {K}_{i} < {K}_{*}} \frac{{Put}_{t} ( {K}_{i} , T , {T}_{D} , {T}_{N} )}{{K}_{i}^{2}} Δ {K}_{i} + \\ {\sum }_{i : {K}_{i} \geq {K}_{*}} \frac{{Call}_{t} ( {K}_{i} , T , {T}_{D} , {T}_{N} )}{{K}_{i}^{2}} Δ {K}_{i}\end{matrix} ] - \\ {( \frac{{F}_{t} ( {T}_{D} , {T}_{N} ) - {K}_{*}}{{K}_{*}} )}^{2}\end{matrix} ]}$$
wherein:
t denotes a time at which the government bond volatility index is calculated;
T denotes a time of expiry of options on government bond derivatives;
T_{D} denotes a time of maturity of government bond derivatives underlying the options where T_{D}≥T;
T_{N} denotes a time of expiry of government bonds;
Z+1 denotes a total number of options used in the index calculation;
K₀ denotes the lowest strike of the Z+1 options;
Kᵢ denotes the i^{th} highest strike of the Z+1 options;
K_{Z} denotes the highest strike of the Z+1 options;
ΔKᵢ=1/2(Kᵢ₊₁−Kᵢ₋₁) for i≥1, and ΔK₀=(K₁−K₀), ΔK_{Z}=(K_{Z}−K_{Z-1});
if the price is observable at time t, then Fₜ(T_{D},T_{N}) is a price at time t of a government bond derivative contract underlying the put and call options, expiring at T_{D} with an underlying government bond maturing at T_{N};
if the price is not observable at time t, then Fₜ(T_{D},T_{N}) is the strike at which the difference between the put and call prices is smallest;
if there exists an option struck at Fₜ(T_{D},T_{N}), then K* equals Fₜ(T_{D},T_{N});
if there does not exist an option struck at Fₜ(T_{D},T_{N}), then K* is the first available strike below Fₜ(T_{D},T_{N});
Pₜ(T) is a price at time t of a zero-coupon non-defaultable bond maturing at T;
Putₜ(Kᵢ,T,T_{D},T_{N})is a price at time t of a put option, struck at Kᵢ, expiring at T, and having an underlying government bond derivative expiring at T_{D} with an underlying bond maturing at T_{N};
Callₜ(Kᵢ,T,T_{D},T_{N}) is a price at time t of a call option, struck at Kᵢ, expiring at T, and having an underlying government bond derivative expiring at T_{D} with an underlying bond maturing at T_{N}; and
GB-VI(t,T,T_{D},T_{N}) is the value of the government bond volatility index at time t calculated based on options expiring at T on government bond derivatives expiring at T_{D} with an underlying bond maturing at T_{N}.

14. The non-transitory computer readable storage medium of claim 12, wherein the government bond volatility index is calculated at time t according to the equation:
$$GB - {VI}^{bp} ( t , T , {T}_{D} , {T}_{N} ) ≡ {100}^{2} \times \sqrt{\frac{1}{( T - t )} [ \begin{matrix}\frac{2}{{P}_{t} ( T )} [ \begin{matrix}{\sum }_{i : {K}_{i} < {K}_{*}} {Put}_{t} ( {K}_{i} , T , {T}_{D} , {T}_{N} ) Δ {K}_{i} + \\ {\sum }_{i : {K}_{i} \geq {K}_{*}} {Call}_{t} ( {K}_{i} , T , {T}_{D} , {T}_{N} ) Δ {K}_{i}\end{matrix} ] - \\ {( {F}_{t} ( {T}_{D} , {T}_{N} ) - {K}_{*} )}^{2}\end{matrix} ]}$$
wherein:
t denotes a time at which the government bond volatility index is calculated;
T denotes a time of expiry of options on government bond derivatives;
T_{D} denotes a time of maturity of government bond derivatives underlying the options where T_{D}≥T;
T_{N} denotes a time of expiry of government bonds;
Z+1 denotes a total number of options used in the index calculation;
K₀ denotes the lowest strike of the Z+1 options;
Kᵢ denotes the i^{th} highest strike of the Z+1 options;
K_{Z} denotes the highest strike of the Z+1 options;
ΔKᵢ=1/2(Kᵢ₊₁−Kᵢ₋₁) for i≥1, and ΔK₀=(K₁−K₀), ΔK_{Z}=K_{Z-1});
if the price is observable at time t, then Fₜ(T_{D},T_{N}) is a price at time t of a government bond derivative contract underlying the put and call options, expiring at T_{D} with an underlying government bond maturing at T_{N};
if the price is not observable at time t, then Fₜ(T_{D},T_{N}) is the strike at which the difference between the put and call prices is smallest;
if there exists an option struck at Fₜ(T_{D},T_{N}), then K* equals Fₜ(T_{D},T_{N});
if there does not exist an option struck at Fₜ(T_{D},T_{N}), then K* is the first available strike below Fₜ(T_{D},T_{N});
Pₜ(T) is a price at time t of a zero-coupon non-defaultable bond maturing at T;
Putₜ(Kᵢ,T,T_{D},T_{N}) is a price at time t of a put option, struck at Kᵢ, expiring at T, and having an underlying government bond derivative expiring at T_{D} with an underlying bond maturing at T_{N};
Callₜ(Kᵢ,T,T_{D},T_{N}) is a price at time t of a call option, struck at Kᵢ, expiring at T, and having an underlying government bond derivative expiring at T_{D} with an underlying bond maturing at T_{N}; and
GB-VI^{bp}(t,T,T_{D},T_{N}) is the value of the government bond volatility index at time t calculated based on options expiring at T on government bond derivatives expiring at T_{D} with an underlying bond maturing at T_{N}.

15. The non-transitory computer readable storage medium of claim 12,
wherein, in the absence of accrued coupons at time T, the government bond volatility index is calculated at time t according to the equation:
$$GB - {VI}_{Y}^{bp} ( t , T , {T}_{D} , {T}_{N} ) ≡ 100 \times {\hat{P}}^{- 1} [ \frac{GB - {VI}^{bp} ( t , T , {T}_{D} , {T}_{N} )}{GB - VI ( t , T , {T}_{D} , {T}_{N} )} ] \times GB - VI ( t , T , {T}_{D} , {T}_{N} )$$
$$where$$
$$\hat{P} ( y ) ≡ {\sum }_{i = 1}^{N} \frac{{C}_{i}}{n} {( 1 + \frac{y}{n} )}^{- i} + 100 {( 1 + \frac{y}{n} )}^{- N} ;$$
and, wherein, in the presence of accrued coupons at time T with the next coupon due at tⱼ, the government bond volatility index is calculated at time t according to the equation:
$$GB - {VI}_{Y}^{bp} ( t , T , {T}_{D} , {T}_{N} ) ≡ 100 \times {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] \times GB - VI ( t , T , {T}_{D} , {T}_{N} )$$
$$where$$
$${\hat{P}}_{T} ( x ) ≡ {\sum }_{i = j}^{N} \frac{{C}_{i}}{n} {( 1 + x )}^{- \frac{d c ( {t}_{i} - T )}{d c ( year )}} + 100 {( 1 + x )}^{- \frac{d c ( {t}_{N} - T )}{d c ( year )}}$$
$$and$$
$$GB - VI ( t , T , {T}_{D} , {T}_{N} ) ≡ 100 \times \sqrt{\frac{1}{( T - t )} [ \begin{matrix}\frac{2}{{P}_{t} ( T )} [ \begin{matrix}{\sum }_{i : {K}_{i} < {K}_{*}} \frac{{Put}_{t} ( {K}_{i} , T , {T}_{D} , {T}_{N} )}{{K}_{i}^{2}} Δ {K}_{i} + \\ {\sum }_{i : {K}_{i} \geq {K}_{*}} \frac{{Call}_{t} ( {K}_{i} , T , {T}_{D} , {T}_{N} )}{{K}_{i}^{2}} Δ {K}_{i}\end{matrix} ] - \\ {( \frac{{F}_{t} ( {T}_{D} , {T}_{N} ) - {K}_{*}}{{K}_{*}} )}^{2}\end{matrix} ]}$$
$$and$$
$$GB - {VI}^{bp} ( t , T , {T}_{D} , {T}_{N} ) ≡ {100}^{2} \times \sqrt{\frac{1}{( T - t )} [ \begin{matrix}\frac{2}{{P}_{t} ( T )} [ \begin{matrix}{\sum }_{i : {K}_{i} < {K}_{*}} {Put}_{t} ( {K}_{i} , T , {T}_{D} , {T}_{N} ) Δ {K}_{i} + \\ {\sum }_{i : {K}_{i} \geq {K}_{*}} {Call}_{t} ( {K}_{i} , T , {T}_{D} , {T}_{N} ) Δ {K}_{i}\end{matrix} ] - \\ {( {F}_{t} ( {T}_{D} , {T}_{N} ) - {K}_{*} )}^{2}\end{matrix} ]}$$
wherein:
t denotes a time at which the government bond volatility index is calculated;
T denotes a time of expiry of options on government bond derivatives;
tⱼ is the first coupon payment on or after T;
T_{D} denotes a time of maturity of government bond derivatives underlying the options where T_{D}≥T;
T_{N} denotes a time of expiry of government bonds;
Z+1 denotes a total number of options used in the index calculation;
K₀ denotes the lowest strike of the Z+1 options;
Kᵢ denotes the i^{th} highest strike of the Z+1 options;
K_{Z} denotes the highest strike of the Z+1 options;
ΔKᵢ=1/2(Kᵢ₊₁−Kᵢ₋₁) for i≥1, and ΔK₀=(K₁−K₀), ΔK_{Z}=(K_{Z}−K_{Z-1});
if the price is observable at time t, then Fₜ(T_{D},T_{N}) is a price at time t of a government bond derivative contract underlying the put and call options, expiring at T_{D} with an underlying government bond maturing at T_{N};
if the price is not observable at time t, then Fₜ(T_{D},T_{N}) is the strike at which the difference between the put and call prices is smallest;
if there exists an option struck at Fₜ(T_{D},T_{N}), then K* equals Fₜ(T_{D},T_{N});
if there does not exist an option struck at Fₜ(T_{D},T_{N}), then K* is the first available strike below Fₜ(T_{D},T_{N});
Pₜ(T) is a price at time t of a zero-coupon non-defaultable bond maturing at T;
Putₜ(Kᵢ,T,T_{D},T_{N}) is a price at time t of a put option, struck at Kᵢ, expiring at T, and having an underlying government bond derivative expiring at T_{D} with an underlying bond maturing at T_{N};
Callₜ(Kᵢ,T,T_{D},T_{N}) is a price at time t of a call option, struck at Kᵢ, expiring at T, and having an underlying government bond derivative expiring at T_{D} with an underlying bond maturing at T_{N};
N denotes the total number of coupon payments of a government bond;
Cᵢ denotes the amount of the i^{th} coupon out of N coupons of a government bond;
n denotes the frequency of coupon payments per annum of a government bond;
y denotes the yield of a government bond;
x denotes the yield of a government bond;
\hat{P}(y) is a bond price corresponding to a bond yield of a coupon-bearing government bond;
\hat{P}⁻¹(y) is the functional inverse of \hat{P}(y);
\hat{P}_{T}(x) is a bond price at time T corresponding to a bond yield of a coupon-bearing government bond;
\hat{P}_{T}⁻¹(x) is the functional inverse of \hat{P}_{T}(x);
dc(year) is the number of days in a year based on a day count convention used for the government bond;
dc(T-t)is the number of days between t and T based on a day count convention used for the government bond;
GB-VI_{Y}^{bp}(t,T,T_{D},T_{N}) is the value of the government bond volatility index in terms of basis point yield volatility at time t calculated based on options expiring at T on government bond derivatives expiring at T_{D} with an underlying bond maturing at T_{N};
GB-VI^{bp}(t,T,T_{D},T_{N}) is the value of the government bond volatility index in terms of basis point price volatility at time t calculated based on options expiring at T on government bond derivatives expiring at T_{D} with an underlying bond maturing at T_{N}; and
GB-VI(t,T,T_{D},T_{N}) is the value of the government bond volatility index in terms of percentage price volatility at time t calculated based on options expiring at T on government bond derivatives expiring at T_{D} with an underlying bond maturing at T_{N}.

16. The non-transitory computer readable storage medium of claim 12, wherein the government bond volatility index is calculated at time t according to the equation:
$$GB - {VI}_{Yd}^{bp} ( t , T , {T}_{D} , {T}_{N} ) ≡ \frac{\begin{matrix}100 \times ( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] ) \times GB - \\ {VI}^{bp} ( t , T , {T}_{D} , {T}_{N} )\end{matrix}}{\begin{matrix}{\sum }_{i = j}^{N} \frac{{C}_{i}}{n} {( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] )}^{- \frac{d c ( {t}_{i} - T )}{d c ( year )}} ( \frac{d c ( {t}_{i} - T )}{d c ( year )} ) + \\ 100 {( 1 + {\hat{P}}_{T}^{- 1} [ \frac{GB - {VI}^{bp} ( t , T , {T}_{D} , {T}_{N} )}{GB - VI ( t , T , {T}_{D} , {T}_{N} )} ] )}^{- \frac{d c ( {t}_{N} - T )}{d c ( year )}} ( \frac{d c ( {t}_{N} - T )}{d c ( year )} )\end{matrix}}$$
$$where$$
$${\hat{P}}_{T} ( x ) ≡ {\sum }_{i = j}^{N} \frac{{C}_{i}}{n} {( 1 + x )}^{- \frac{d c ( {t}_{i} - T )}{d c ( year )}} + 100 {( 1 + x )}^{- \frac{d c ( {t}_{N} - T )}{d c ( year )}}$$
$$and$$
$$GB - VI ( t , T , {T}_{D} , {T}_{N} ) ≡ 100 \times \sqrt{\frac{1}{( T - t )} [ \begin{matrix}\frac{2}{{P}_{t} ( T )} [ \begin{matrix}{\sum }_{i : {K}_{i} < {K}_{*}} \frac{{Put}_{t} ( {K}_{i} , T , {T}_{D} , {T}_{N} )}{{K}_{i}^{2}} Δ {K}_{i} + \\ {\sum }_{i : {K}_{i} \geq {K}_{*}} \frac{{Call}_{t} ( {K}_{i} , T , {T}_{D} , {T}_{N} )}{{K}_{i}^{2}} Δ {K}_{i}\end{matrix} ] - \\ {( \frac{{F}_{t} ( {T}_{D} , {T}_{N} ) - {K}_{*}}{{K}_{*}} )}^{2}\end{matrix} ]}$$
$$and$$
$$GB - {VI}^{bp} ( t , T , {T}_{D} , {T}_{N} ) ≡ {100}^{2} \times \sqrt{\frac{1}{( T - t )} [ \begin{matrix}\frac{2}{{P}_{t} ( T )} [ \begin{matrix}{\sum }_{i : {K}_{i} < {K}_{*}} {Put}_{t} ( {K}_{i} , T , {T}_{D} , {T}_{N} ) Δ {K}_{i} + \\ {\sum }_{i : {K}_{i} \geq {K}_{*}} {Call}_{t} ( {K}_{i} , T , {T}_{D} , {T}_{N} ) Δ {K}_{i}\end{matrix} ] - \\ {( {F}_{t} ( {T}_{D} , {T}_{N} ) - {K}_{*} )}^{2}\end{matrix} ]}$$
wherein:
t denotes a time at which the government bond volatility index is calculated;
T denotes a time of expiry of options on government bond derivatives;
T_{D} denotes a time of maturity of government bond derivatives underlying the options where T_{D}≥T;
T_{N} denotes a time of expiry of government bonds;
Z+1 denotes a total number of options used in the index calculation;
K₀ denotes the lowest strike of the Z+1 options;
Kᵢ denotes the i^{th} highest strike of the Z+1 options;
K_{Z} denotes the highest strike of the Z+1 options;
ΔKᵢ=1/2(Kᵢ₊₁−Kᵢ₋₁) for i≥1, and ΔK₀=(K₁−K₀), ΔK_{Z}=(K_{Z}−K_{Z-1});
if the price is observable at time t, then Fₜ(T_{D},T_{N}) is a price at time t of a government bond derivative contract underlying the put and call options, expiring at T_{D} with an underlying government bond maturing at T_{N};
if the price is not observable at time t, then Fₜ(T_{D},T_{N}) is the strike at which the difference between the put and call prices is smallest;
if there exists an option struck at Fₜ(T_{D},T_{N}), then K* equals Fₜ(T_{D},T_{N});
if there does not exist an option struck at Fₜ(T_{D},T_{N}), then K* is the first available strike below Fₜ(T_{D},T_{N});
Pₜ(T) is a price at time t of a zero-coupon non-defaultable bond maturing at T;
Putₜ(KᵢT,T_{D},T_{N}) is a price at time t of a put option, struck at Kᵢ, expiring at T, and having an underlying government bond derivative expiring at T_{D} with an underlying bond maturing at T_{N};
Callₜ(Kᵢ,T,T_{D},T_{N}) is a price at time t of a call option, struck at Kᵢ, expiring at T, and having an underlying government bond derivative expiring at T_{D} with an underlying bond maturing at T_{N};
N denotes the total number of coupon payments of a government bond;
Cᵢ denotes the amount of the i^{th} coupon out of N coupons of a government bond;
n denotes the frequency of coupon payments per annum of a government bond;
x denotes the yield of a government bond;
\hat{P}_{T}(x) is a bond price corresponding to a bond yield of a coupon-bearing government bond;
\hat{P}_{T}⁻¹(x) is the functional inverse of \hat{P}_{T}(x);
dc(year) is the number of days in a year based on a day count convention used for the government bond;
dc(T-t) is the number of days between t and T based on a day count convention used for the government bond;
tⱼ is the first coupon payment on or after T;
GB-VI_{Yd}^{bp}(t,T,T_{D},T_{N}) is the value of the government bond volatility index in terms of basis point yield volatility at time t calculated based on options expiring at T on government bond derivatives expiring at T_{D} with an underlying bond maturing at T_{N};
GB-VI^{bp}(t,T,T_{D},T_{N}) is the value of the government bond volatility index in terms of basis point price volatility at time t calculated based on options expiring at T on government bond derivatives expiring at T_{D} with an underlying bond maturing at T_{N}; and
GB-VI(t,T,T_{D},T_{N}) is the value of the government bond volatility index in terms of percentage price volatility at time t calculated based on options expiring at T on government bond derivatives expiring at T_{D} with an underlying bond maturing at T_{N}.

17. The non-transitory computer readable storage medium of claim 10, wherein the at least one processor is further caused to:
create a standardized exchange-traded derivative instrument based on the government bond volatility index; and
transmit data regarding the standardized exchange-traded derivative.

18. The non-transitory computer readable storage medium of claim 17, wherein transmitting data regarding the standardized exchange-traded derivative instrument includes transmitting data regarding one or more of a settlement price, a bid price, an offer price, or a trade price of the standardized exchange-traded derivative instrument.
